(19) United States
(12) Patent Application Publication
(10) Pub. No.: US 2026/0202195 A1
(43) Pub. Date: Jul. 16, 2026

(54) RAISED ACCESS FLOOR PLANARITY MEASURING EQUIPMENT AND ELEVATING MECHANISM

(71) Applicant: VERO VERIA CORPORATION, Taipei (TW)

(72) Inventors: CHIEN-TEH HUANG, Taipei (TW); Shan-Hang Chen, Taipei (TW); Ching-Heng Huang, Taipei (TW)

(21) Appl. No.: 19/075,821

(22) Filed: Mar. 11, 2025

(30) Foreign Application Priority Data
Jan. 14, 2025 (TW) 114101416

(51) Int. Cl. G01B 21/30; B65G 47/22

(52) U.S. Cl. CPC G01B 21/30; B65G 47/22; B65G 2201/022

(57) ABSTRACT

A planarity measurement device, for a raised access floor includes a conveying device, a measuring equipment, a positioning device and an elevating device for the raised access floor. The measuring equipment includes a sensor fixing plate, a sensor, a probe and four plate zero point positioning blocks. The sensor is provided on the sensor fixing plate, the probe is connected to the sensor, and the four plate zero point positioning blocks are provided on the sensor fixing plate. When the conveying device conveys the raised access floor to the measuring station, the positioning device is used to locate the position of the side panels of the raised access floor. The elevating device of the elevated floor includes four elevating mechanisms and a driving motor. The driving motor drives the four elevating mechanisms to move the elevated floor and contact the four plate surface zero point positioning blocks.

### CROSS REFERENCE TO RELATED APPLICATION

This application claims the benefits of Taiwan application Serial No. 114101416 filed on Jan. 14, 2025, the disclosures of which are incorporated by references herein in its entirety.

### TECHNICAL FIELD

The disclosure is related to a measuring equipment and elevating mechanism, and more particularly to an elevating mechanism and an equipment for measuring the planarity of a raised access floor.

### BACKGROUND

Raised access floor is a floor system widely used in semiconductor factories, offices, computer rooms and other places. Raised access floor basically consists of a supporting frame and multiple floor panels with adjustable height. These floor panels are suspended above the ground to constitute a space for arranging wires, cables, pipes and other facilities, and can help improve air circulation and heat dissipation.

In order to ensure that the surface of the entire floor is flat, it is necessary to check the planarity of the raised access floor to avoid errors or structural problems after assembly. The method of measuring the planarity of the raised access floor is usually to use visual observation of the horizontal line to check the planarity, which requires comparison of two or more points; there are also methods of using a ruler (straight ruler) or a measuring rod, which is placed on the raised access floor to check the planarity of the floor. Place a ruler at different locations on the floor and check if it is touching the ground. If there are any uneven spots, it means there is a problem with the planarity. However, these methods are often labor-intensive and rely on the experience and judgment of on-site engineering personnel, which results in reduced overall engineering efficiency.

### SUMMARY

The disclosed embodiment provides a planarity measuring equipment for raised access floors, which is suitable for transmitting and measuring the planarity of raised access floors, improving measurement accuracy, reducing errors or structural problems after assembly, and improving overall engineering efficiency.

In addition, in one embodiment of the raised access floor planarity measurement device, the raised access floor elevating device has four elevating mechanisms constitute as a synchronous drive mechanism to synchronously perform elevating actions so that the raised access floor can be elevated or lowered to a predetermined position, thereby avoiding the occurrence of position differences in the elevating actions of the four elevating mechanisms.

In addition, the elevating mechanism disclosed herein can not only quickly raise the height to a predetermined height by means of its fast elevating module, but can also compensate for the fitting error by means of air pressure regulation of the slow elevating module. One of the embodiments of the raised access floor planarity measuring equipment may also include an elevating mechanism.

An embodiment of the present disclosure provides a planarity measuring equipment for a raised access floor, which is suitable for transmitting and measuring the planarity of a top plate of a raised access floor. The plurality of side plates of the raised access floor are vertically connected to the four sides of the top plate. The planarity measuring equipment for the raised access floor includes a conveying device, a measuring equipment, a positioning device, and a elevating device for the raised access floor. The conveying device includes a material waiting station, a measuring station and an output station along a conveying direction, wherein the measuring station is positioned between the material waiting station and the output station, and the conveying device is used for conveying the raised access floor along the conveying direction. The measuring equipment is positioned at the measuring station, moreover, the measuring equipment includes a sensor fixing plate, multiple sensors, multiple probes, and four plate surface zero point positioning blocks, wherein the sensor fixing plate includes a accommodating portion and a detection surface, and the sensors are respectively provided at different positions of the accommodating portion, the positions of the probes correspond to the positions of the sensors, and the probes are connected to the corresponding sensors, one end of the probes protrudes from the detection surface of the sensor fixing plate, and these probes are provided in an array, and the four plate surface zero point positioning blocks are respectively provided at the four corners of the detection surface of the sensor fixing plate. The positioning device is positioned at the measuring station, wherein when the conveying device is used to convey the raised access floor to the measuring station along the conveying direction, the top plate of the raised access floor is positioned below the sensor fixing plate, and the positioning device is used to locate the position of the side plate of the raised access floor so that the position of the top plate can correspond to the position of the detection surface of the sensor fixing plate. The elevating device of the raised access floor is positioned at the measuring station. The elevating device of the raised access floor includes four elevating mechanisms and at least one driving motor. The four elevating mechanisms are respectively used to support the four corners of the raised access floor, and the positions of the four elevating mechanisms correspond to the positions of the fourth board zero-point positioning block in the measuring equipment. At least the driving motor drives the four elevating mechanisms to move synchronously along a elevating direction to move the raised access floor along the elevating direction and contact the fourth board zero-point positioning block

In one embodiment, the five probes are provided at four sides respectively, and a first row, a second row and a third row of probes are provided within the probes positioned at the four sides. The first row and the third row are respectively provided with six probes, and the six probes are provided in two rows. The second row of probes is provided with five probes, and the probes face the top plate.

In one embodiment, the positioning device includes a first positioning element, a second positioning element, a third positioning element, a fourth positioning element, a fifth positioning element, a first pushing cylinder, and a second pushing cylinder, moreover, the first positioning element, the first pushing cylinder, the second positioning element, and the second pushing cylinder are provided along the conveying direction, what is more, the first pushing cylinder is connected to the first positioning element, the second pushing cylinder is connected to the second positioning element, and the third positioning element, the fourth positioning element, and the fifth positioning element are provided on both sides of the conveying direction, furthermore, the first positioning element includes a positioning plate, a rack, and a gear, wherein, one end of the rack is connected to the first pushing cylinder, and the other end of the rack is connected to the gear, moreover, the gear is connected to the positioning plate, what is more, the conveying device includes a conveying structure which is a chain transmission drive structure, has a conveying direction, furthermore, the conveying structure includes two chain assemblies. The measuring equipment is provided on the two chain assemblies. Lastly, the first positioning element, the second positioning element, the first pushing cylinder, and the second pushing cylinder are respectively positioned between the two chain assemblies. By driving the second positioning element, the second pushing cylinder can be elevated and moved in a elevating direction, so that the second pushing cylinder can protrude from the setting position of the two chain assemblies.

In one embodiment, the conveying structure includes a main body, a first gear assembly and a second gear assembly, and a driving motor. The first gear assembly and the second gear assembly are respectively provided at two ends of the main body, and the chain assembly is respectively connected to the first gear assembly and the second gear assembly. The driving motor is connected to the second gear assembly. When the driving motor drives the second gear assembly, the second gear assembly drives the chain assembly to rotate. The chain assembly rotates to drive the first gear assembly to rotate, so that the first gear assembly and the second gear assembly can rotate synchronously making the chain assembly move along the conveying direction.

In one embodiment, the conveying device includes a first frame, a second frame, a supporting frame, and a conveying structure. The first frame and the second frame are respectively provided under the conveying structure while the supporting frame is positioned between the first frame and the second frame, wherein the first frame is positioned at the material waiting station in the conveying structure, while the second frame is positioned at the output station in the conveying structure, moreover, the supporting frame is positioned at the measuring station in the conveying structure, what is more, the measuring equipment, the positioning device and the elevating device of the raised access floor are respectively provided between the first frame and the second frame, furthermore, the measuring equipment, the positioning device and the elevating device of the raised access floor are respectively provided above the supporting frame. The raised access floor planarity measurement device further includes two limiting devices, which are respectively provided on both sides of the conveying structure.

In one embodiment, the elevating device of the raised access floor includes a belt, two first supporting plates and two second supporting plates, wherein the two ends of the first supporting plates are respectively connected to the second supporting plates to constitute a square frame, and the four elevating mechanisms include a fast elevating module and a slow elevating module, wherein each fast elevating module includes a screw rod and a transmission wheel, each slow elevating module includes a contact block, the lower ends of the screw rods of the four elevating mechanisms are respectively fixed to both ends of the first supporting plates, moreover, the belt is wound around the corresponding transmission wheels and the drive motors of the four elevating mechanisms to constitute a synchronous drive mechanism, and the four contact blocks correspond to the positions of the four plate surface zero point positioning blocks.

In one embodiment, the four elevating mechanisms include a fast elevating module and a slow elevating module respectively. The fast elevating module is fixed above the corresponding slow elevating module, and each slow elevating module rises and falls synchronously with the corresponding fast elevating module.

In one embodiment, each of the fast elevating modules includes a T-type nut connector and a connecting flange, wherein the T-type nut connector includes a T-type nut, at least one bearing, a nut, a transmission wheel connecting piece, and a transmission wheel, wherein the T-type nut can be fixed together with the transmission wheel and rotate synchronously through the transmission wheel connecting piece, while the connecting flange includes an upper connecting flange and a lower connecting flange, wherein the upper connecting flange is connected to the lower connecting flange, what is more, an upper end of the screw rod is fixed to the lower connecting flange, and the lower end of the screw rod is sequentially penetrated by the nut, the T-type nut, at least one bearing, the transmission wheel connecting piece, and the transmission wheel.

In one embodiment, each of the four elevating mechanisms include a T-type connector, while each of slow elevating module each includes a cylinder power source, moreover, each of cylinder power source includes a cylinder body and a piston, moreover, each piston can move within the corresponding cylinder body, while each contact block is fixed to the top portion of the corresponding piston, so that the cylinder power source can slowly elevates and lower the contact block to adjust the height of the contact block, what is more, one end of each T-type connector is connected to a connecting flange, while and a fixed base is set at the other end of the T-type connector, finally, the connecting flange and the fixed base on both ends of the T-type connector are respectively connected and fixed to the fast elevating module and the slow elevating module.

In one embodiment, the cylinder power source includes at least one inlet and outlet hole and a plurality of fixed rods wherein at least one inlet and outlet hole is provided on the cylinder body. The piston includes a protruding end connected to the top portion. Moreover, one end of each of the fixed rods is respectively passed through the cylinder body, and the other end of each of the fixed rods is connected to the top portion, so that the piston and the fixed rods can be linked to the contact block.

In one embodiment, the T-type nut connector includes a bearing seat body in which contains a bearing, the bearing is positioned between the T-type nut and the bearing seat body while the nut is locked on the upper end of the T-type nut to fix the position of the bearing, moreover, the transmission wheel connecting piece is fixed inside the transmission wheel which drives the transmission wheel connecting piece and the T-type nut connected to it to rotate, what is more, the T-type nut can drive the screw rod to perform up and down linear motion through rotation.

In one embodiment, the T-type nut connector includes a retaining frame, a C-type snap ring, and two deep groove bearings wherein the C-type snap ring, the two deep groove bearings, and the retaining frame are respectively penetrated through the outer periphery of the T-type nut, moreover, one of the deep groove bearings is respectively provided at the upper and lower ends of the retaining frame. What is more the positions of the two deep groove bearings are fixed by the retaining frame, and the C-type snap ring is positioned between a deep groove bearing and the bearing to fix the position of the bearing.

In one embodiment, the upper end of the screw rod is connected and fixed to the lower end of a first bolt, wherein the upper end of the first bolt is a bolt head, the first bolt head is passed through a countersunk hole in the lower connecting flange and is locked and fixed in a screw hole at the upper end of the screw rod so as to fix the screw rod and the lower connecting flange into one body, moreover, the bolt head is fixed and connected to the countersunk hole of the lower connecting flange, what is more, the fixed base of the T-shaped connecting piece uses a second bolt to penetrate through the bottom of the cylinder power source and is locked and fixed in the screw hole of the fixed base, so as to connect and fix the cylinder power source to the fixed base.

In one embodiment, by the use of at least one fixing screw to sequentially penetrated through a corresponding perforation of the transmission wheel, the transmission wheel connecting piece and the C-type nut to fix the transmission wheel and the C-type nut into one body.

Another embodiment of the present disclosure provides a elevating mechanism, including a fast elevating module, a slow elevating module, and a T-shaped connecting piece wherein the slow elevating module is fixed above the fast elevating module, the fast elevating module can be quickly elevated to a predetermined height and the slow elevating module rises and falls synchronously with the fast elevating module, moreover, the fast elevating module includes a T-type nut connector, a connecting flange, and a screw rod wherein the T-type nut connector includes a T-type nut, at least one bearing, a nut, a transmission wheel connecting piece, and a transmission wheel, what is more, the T-type nut can be fixed together with the transmission wheel through the transmission wheel connecting piece and rotate synchronously, furthermore, the connecting flange includes an upper connecting flange and a lower connecting flange and the upper connecting flange is connected to the lower connecting flange wherein an upper end of the screw rod is fixed to the lower connecting flange, and the lower end of the screw rod is sequentially penetrated through the nut, the C-type nut, at least the bearing, the transmission wheel connecting piece and the transmission wheel, furthermore, the slow elevating module includes a cylinder power source and a contact block, wherein the cylinder power source includes a cylinder body and a piston, and wherein the piston can move inside the cylinder body, moreover, the contact block is fixed to one of the tops of the piston so that the cylinder power source can slowly raises and lowers the contact block to adjust the height of the contact block, what is more, one end of the T-type connector is connected to a connecting flange, while the other end of the T-type connector is provided with a fixed base. furthermore, the connecting flanges and the fixed bases at both ends of the T-type connector are respectively connected and fixed the fast elevating module and the slow elevating module.

Based on the above, the present invention measures the planarity of the raised access floor during the transmission process, thereby improving the measurement accuracy, reducing errors or structural problems after assembly, and improving the overall engineering efficiency.

Furthermore, the number of probes and sensors disclosed in the present invention can be adjusted according to the size or requirements of the top plate of the raised access floor to be measured, so as to improve the accuracy of measuring planarity.

In addition, the present disclosure uses a plate zero point positioning block to fix and confirm the position of the four corners of the top plate of the measuring equipment and the raised access floor to ensure the relative position of the probe and the top plate.

In addition, during the transmission process, the present invention uses a positioning device to position the four sides of the raised access floor to ensure the relative position of the raised access floor and the measuring equipment to ensure the accuracy of the subsequent measurement.

In addition, the present disclosure discloses a elevating device for a raised access floor, wherein the four elevating mechanisms are constituted as a synchronous driving mechanism to synchronously perform the elevating action, so that the raised access floor can be elevated or lowered to a predetermined position, thereby avoiding the occurrence of position differences in the elevating action of the four elevating mechanisms.

Furthermore, the elevating mechanism disclosed in the present invention has two independent modules, i.e. fast elevating module and slow elevating module, in addition to be able to quickly lift to a predetermined height by use of the fast elevating module, the air pressure regulation can be compensated for the fitting error by the use of the slow elevating module.

In order to make the present disclosure more clearly to be understood, the following content is a detailed description of the embodiments with reference to the accompanying drawings.

### BRIEF DESCRIPTION OF THE DRAWINGS

Brief explanation of the diagram

FIG. 1 is a perspective view of a planarity measuring equipment for a raised access floor according to the present disclosure.

FIG. 2 is a perspective view of a raised access floor according to an embodiment of the present disclosure.

FIG. 3 is a partial three-dimensional schematic diagram of a planarity measuring equipment for a raised access floor according to the present disclosure.

FIG. 4 is a schematic three-dimensional diagram of an embodiment of a measuring equipment according to the present disclosure.

FIG. 5 is a schematic three-dimensional diagram of the reverse side of a measuring equipment according to an embodiment of the present disclosure.

FIG. 6A is a schematic side view of an angle an embodiment of a measuring equipment according to the present disclosure.

FIG. 6B is a schematic side view of another angle of an embodiment of a measuring equipment according to the present disclosure.

FIG. 7 is a three-dimensional schematic diagram of a positioning device and an elevating device for a raised access floor according to the present disclosure.

FIG. 8 is a schematic top view of the positioning device and the elevating device of the raised access floor according to the present disclosure.

FIG. 9 is a side view of a positioning device and an elevating device for a raised access floor according to the present disclosure.

FIG. 10 is a perspective schematic diagram of an embodiment of an elevating device for a raised access floor according to the present disclosure.

FIG. 11 is a schematic diagram of an embodiment of an elevating device for a raised access floor according to the present disclosure in an elevating position.

FIG. 12 is a schematic diagram of an embodiment of an elevating device for a raised access floor according to the present disclosure at an origin position.

FIG. 13A is a schematic diagram of an embodiment of an elevating mechanism in an elevating position according to the present disclosure.

FIG. 13B is a schematic diagram of an embodiment of an elevating mechanism at an origin position according to the present disclosure.

FIG. 14A is an exploded view of the corresponding components in the cross-sectional diagram of the elevating mechanism according to the present disclosure.

FIG. 14B is an exploded view of the lower connecting flange and the screw according to the present disclosure.

FIG. 15A is a cross-sectional view of an embodiment of an elevating mechanism in an elevating position according to the present disclosure.

FIG. 15B is a cross-sectional view of an embodiment of an elevating mechanism at the origin position according to the present disclosure.

### DETAILED DESCRIPTION

The following lists embodiments and describes them in detail with reference to the accompanying drawings, but the provided embodiments are not intended to limit the scope of the present disclosure. In addition, the drawings are for illustration purposes only and are not drawn to scale. For easier understanding, the same elements will be indicated by the same symbols in the following description.

The terms “including”, “comprising”, “having”, etc. mentioned in this disclosure are open-ended terms, which means “including but not limited to”.

In the description of each embodiment, when the terms “first,” “second,” “third,” “fourth,” etc. are used to describe an element, it is only used to distinguish these elements from each other and does not limit the order or importance of these elements.

In the description of each embodiment, the so-called “coupling” or “connection” may refer to two or more elements making direct physical or electrical contact with each other, or making indirect physical or electrical contact with each other, and “coupling” or “connection” may also refer to two or more elements operating or moving with each other.

In the description of each embodiment, the so-called “module” refers to a hardware module, that is, a hardware component that occupies space. In other embodiments, the so-called “module” may also refer to a hardware module plus a software module, that is, the “module” has a software program in addition to a hardware component.

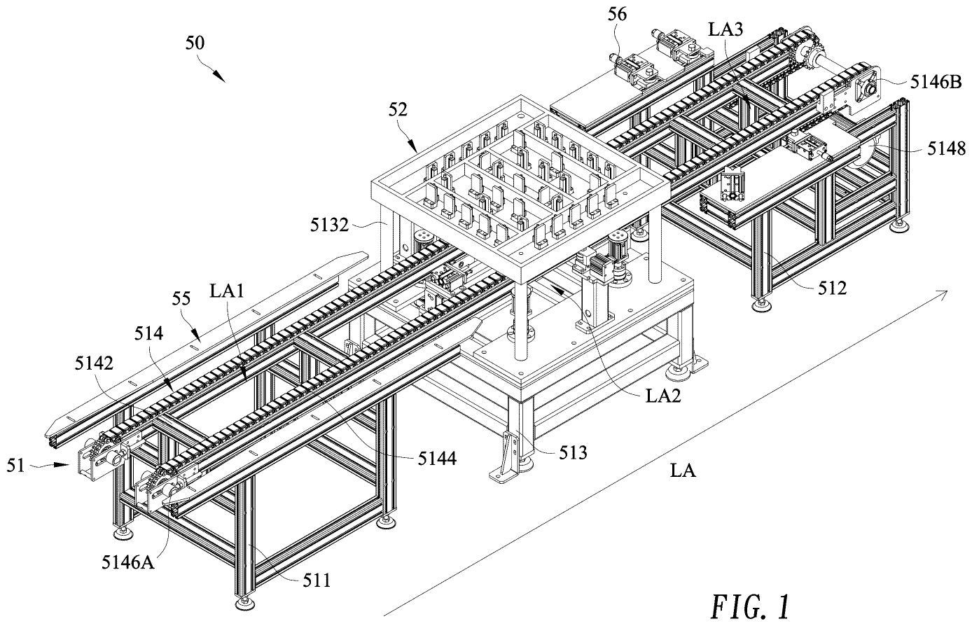

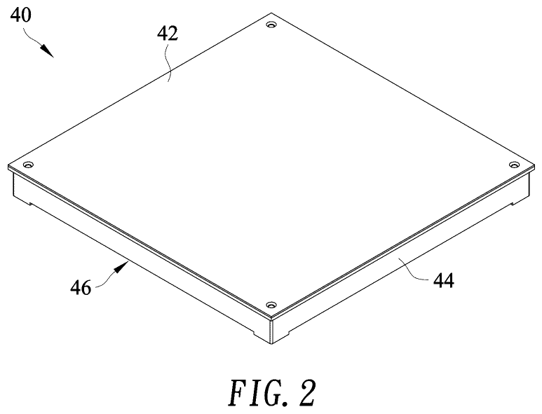

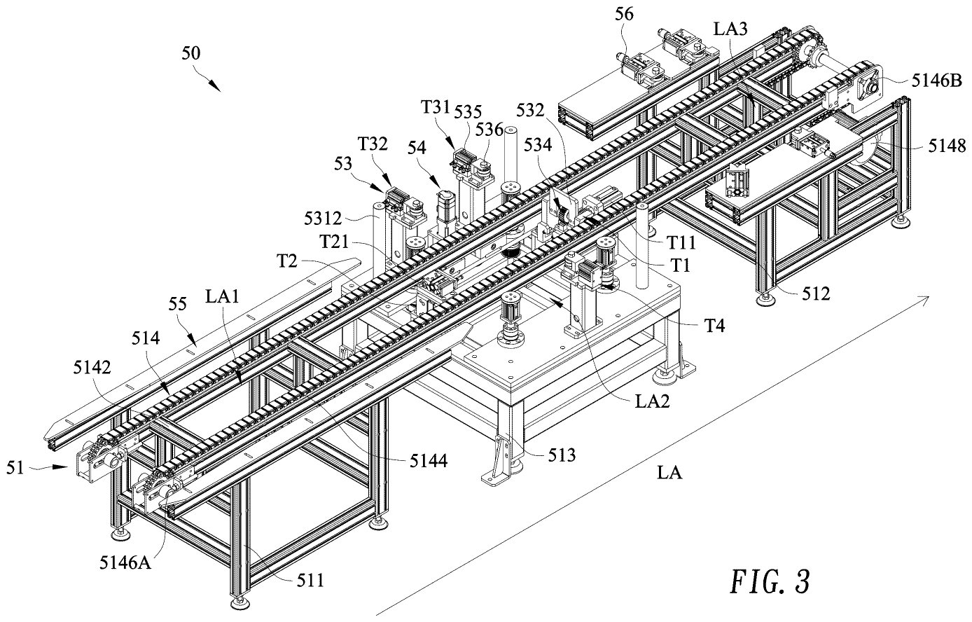

FIG. 1 is a perspective view of a planarity measuring equipment for A raised access floor according to the present disclosure. FIG. 2 is a three-dimensional schematic diagram of an embodiment of A raised access floor according to the present disclosure, and FIG. 3 is a partial three-dimensional schematic diagram of the planarity measurement device, of the raised access floor according to the present disclosure, wherein FIG. 3 omits the measuring device 52 to show the positioning device 53 and the raised access floor elevating device 54 of the raised access floor. Referring to FIG. 1 to FIG. 3, the setting up along a conveying direction LA of the raised access floor planarity measuring equipment 50 disclosed in the present disclosure includes a material waiting station LA1, a measuring station LA2, and an output station LA3, and the measuring station LA2 is positioned between the material material waiting station LA1 and the output station LA3.

For example, as shown in FIG. 2, the raised access floor planarity measuring equipment 50 is suitable for transmitting and measuring the planarity of a top plate 42 of a raised access floor 40. The raised access floor 40 is input from the material waiting station LA1 to the measuring station LA2, and the planarity of the top plate 42 of the raised access floor 40 is measured at the measuring station LA2 where the top plate 42 of the raised access floor is performed planarity measurement. Afterward, the raised access floor is transmitted toward the position after the output station LA3.

It should be noted that the raised access floor 40 disclosed herein and showed in FIG. 2 are in a rectangular shape and has a top plate 42 as well as four side plates 44. These side plates 44 are vertically connected to the four sides of the top plate 42. The size of the raised access floor 40 disclosed herein is, for example, 600 mm×600 mm×60 mm, and is made of materials such as aluminum alloy die-casting.

The raised access floor planarity measuring equipment 50 includes a conveying device 51, a measuring device 52, a positioning device 53, A raised access floor elevating device 54, and a plurality of selectively provided limiting devices 55 and at least one removal positioning element 56, wherein the conveying device 51 is used to convey the raised access floor 40 as shown in FIG. 2 along a conveying direction LA, and the conveying device 51 includes a first frame 511, a second frame 512, and a conveying structure 514.

The conveying structure 514 in the conveying device 51 has a conveying direction LA, and along the conveying direction LA can include a material waiting station LA1, a measuring station LA2, and an output station LA3, wherein the first frame 511 and the second frame 512 are respectively provided under the conveying structure 514 while the first frame 511 is positioned at the material waiting station LA1 in the conveying structure 514, and the second frame 512 is positioned in the output station LA3 of the conveying structure 514.

The measuring device 52, the positioning device 53, and the elevating device 54 of the raised access floor are respectively positioned at the measuring station LA2 in the conveying structure 514, so that the measuring device 52, the positioning device 53 and the elevating device 54 of the raised access floor are all provided between the first frame 511 and the second frame 512. In this way, the raised access floor 40 shown in FIG. 2 can be transported from the first frame 511 positioned at the material material waiting station LA1 to the second frame 512 at the output station LA3 by the conveying structure 514.

In one embodiment, the conveying structure 514 may be a chain transmission drive structure, which includes a main body 5142, a chain assembly 5144, a first gear assembly 5146A and a second gear assembly 5146B, and a driving motor 5148, wherein the main body 5142 is, for example, a frame, and the first frame 511 and the second frame 512 are respectively provided below the main body 5142, and the first gear assembly 5146A and the second gear assembly 5146B are respectively provided at both ends of the main body 5142, and the chain assembly 5144 is respectively connected to the first gear assembly 5146A and the second gear assembly 5146B, and the driving motor 5148 is connected to the second gear assembly 5146B.

When the driving motor 5148 drives the second gear assembly 5146B, the first gear assembly 5146A and the second gear assembly 5146B rotate synchronously. At the same time, the first gear assembly 5146A and the second gear assembly 5146B can drive the chain assembly 5144 to move, so that the chain assembly 5144 can move along the conveying direction LA.

In one embodiment, the back side 46 of the raised access floor 40 as shown in FIG. 2 can be placed on the chain assembly 5144, and the chain assembly 5144 can be used to transport the raised access floor 40 from the material waiting station LA1 to the output station LA3, wherein the back side 46 refers to the other side opposite to the top plate 42, that is, the top plate 42 of the raised access floor 40 does not contact the chain assembly 5144, and when the raised access floor 40 is transported to the measuring station LA2 by the chain assembly 5144, the raised access floor 40 is positioned between the chain assembly 5144 and the measuring device 52, that is, the top plate 42 of the raised access floor 40 will be positioned below the measuring device 52.

The first gear assembly 5146A and the second gear assembly 5146B referred to in the present disclosure are, for example, two gears respectively, and are disposed at two ends of the main body 5142. The two chain assemblies 5144 are respectively disposed on the main body 5142. The chain assembly 5144 may include a chain, a guide groove, a roller, etc., but the present disclosure does not limit the structure of the chain assembly 5144. The driving motor 5148 may include a chain to connect the second gear assembly 5146B, so that the driving motor 5148 drives the second gear assembly 5146B to rotate. At the same time, when the second gear assembly 5146B rotates, it drives the chain assembly 5144 to rotate. The chain assembly 5144 rotates to drive the first gear assembly 5146A to rotate, so that the first gear assembly 5146A and the second gear assembly 5146B can rotate synchronously, thereby achieving the purpose of the conveying device 51 being able to carry at least one raised access floor 40 and convey the raised access floor 40 along the conveying direction LA.

In addition, in one embodiment, the planarity measurement device, 50 of the raised access floor can selectively set a limiting device 55. Taking FIG. 1 as an example, two limiting devices 55 are respectively positioned at the material waiting station LA1, and these two limiting devices 55 are respectively set on both sides of the conveying structure 514, and the setting height of these two limiting devices 55 can be higher than the setting height of the chain assembly 5144.

By setting the limiting device 55, it is ensured that the raised access floor 40 can be restricted and positioned on the chain assembly 5144, so that the raised access floor 40 can operate normally on the conveying device 51. The limiting device 55 is, for example, a plate, and can be set at any position of the conveying device 51 according to actual conditions. In other words, in addition to setting the limiting device 55 at the material material waiting station LA1, it can also be set at the measuring station LA2 or the output station LA3.

In one embodiment, the conveying device 51 further includes a supporting frame 513. The supporting frame 513 is positioned between the first frame 511 and the second frame 512. The supporting frame 513 is positioned at the measuring station LA2 in the conveying structure 514. The measuring device 52, the positioning device 53 and the elevating device 54 of the raised access floor are respectively provided above the supporting frame 513, so that the measuring device 52, the positioning device 53 and the elevating device 54 of the raised access floor are all positioned above the chain assembly 5144 in the conveying structure 514, and the measuring device 52 is provided above the positioning device 53 and the elevating device 54 of the raised access floor.

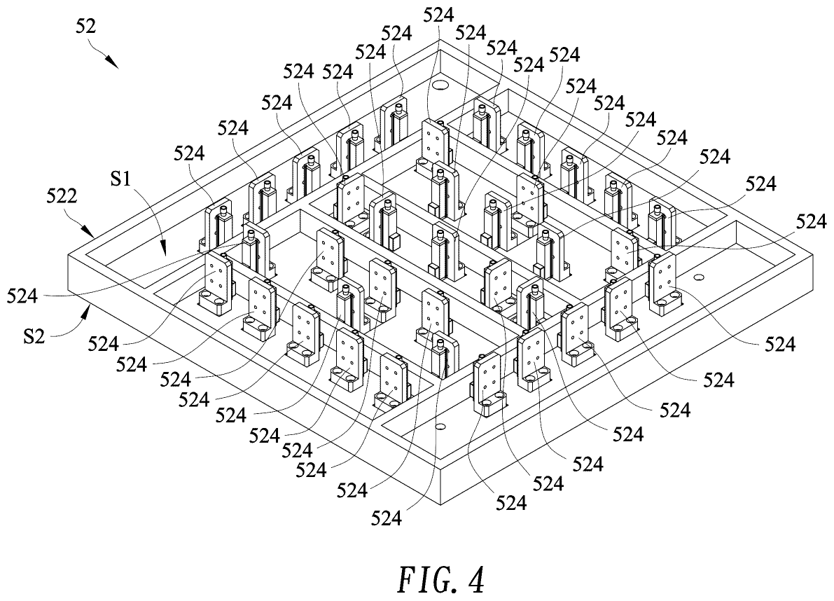

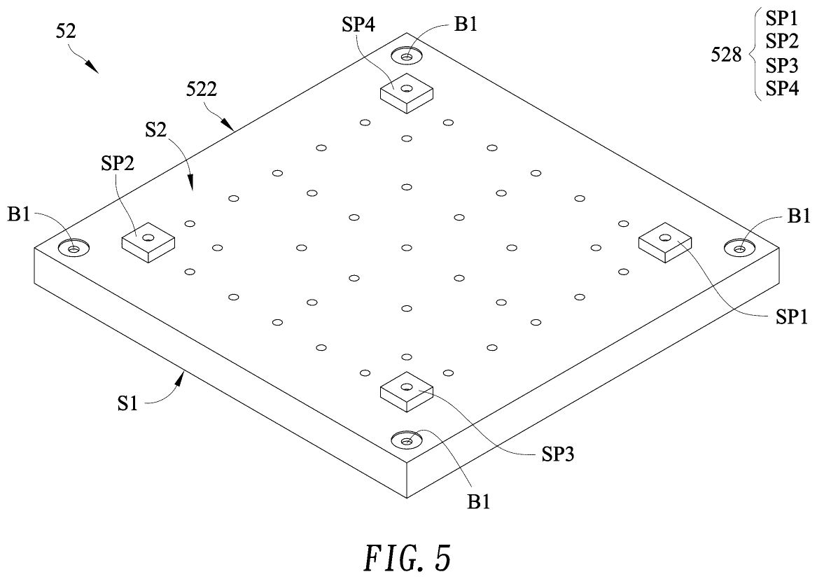

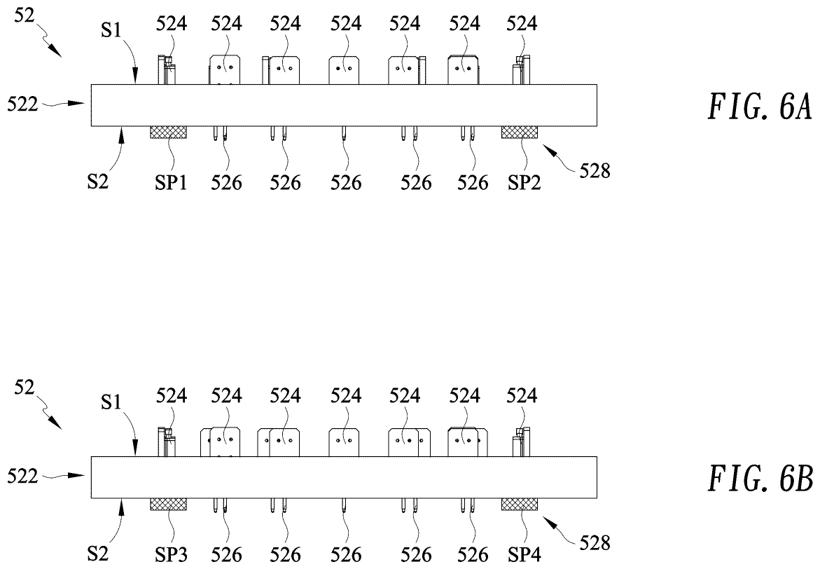

FIG. 4 is a schematic three-dimensional diagram of an embodiment of a measuring equipment according to the present disclosure. FIG. 5 is a schematic three-dimensional diagram of the reverse side of a measuring equipment according to an embodiment of the present disclosure. FIG. 6A is a schematic side view of an embodiment of a measuring equipment according to the present disclosure. FIG. 6B is a schematic side view of another angle of an embodiment of a measuring equipment according to the present disclosure. Please refer to FIG. 1 and FIG. 4 to FIG. 6B, the measuring device 52 of the present disclosure is positioned at the measuring station LA2 in the conveying structure 514, and the measuring device 52 is disposed on the chain assembly 5144. For example, as shown in FIG. 1, four connection posts 5132 are connected to the supporting frame 513, and the bottom of the measuring device 52 is respectively connected to the four connection posts 5132, so that the measuring device 52 is disposed above the supporting frame 513. Furthermore, in one embodiment, both ends of each crossbar 5134 are respectively connected and fixed to the supporting frame 513 to stabilize the position of the supporting frame 513.

The measuring device 52 includes a sensor fixing plate 522, a plurality of sensors 524, a plurality of probes 526, and four plate zero point positioning blocks 528, wherein the sensor fixing plate 522 is a plate body including a receiving portion S1 and a detecting surface S2 opposite to each other. Multiple sensors 524, such as 37 sensors 524, are respectively provided at different positions of the accommodating portion S1, wherein 5 sensors 524 are provided on each side, totaling 25 sensors 524, and 17 sensors 524 are provided within the 25 sensors 524 on each side, so as to measure and simulate different evenly distributed positions of the top plate 42 of the raised access floor 40 as shown in FIG. 2. Furthermore, as shown in FIG. 4, different areas can be set in the accommodation portion S1 according to actual conditions and appropriate numbers of sensors 524 can be correspondingly set. Of course, the number of sensors 524 can be adjusted according to the size or demand of the top plate 42 of the raised access floor 40 actually measured.

The number of probes 526 is consistent with the number of sensors 524, and each probe 526 is connected to a corresponding sensor 524, that is, the position of each probe 526 corresponds to the position of the sensor 524, and one end of each probe 526 protrudes from the detection surface S2 of the sensor fixing plate 522. These probes 526 face and are used to contact the top plate 42 of the raised access floor 40 as shown in FiIG. 2. The data obtained by these probes 526 are received by the corresponding sensors 524. These sensors 524 can receive these data and display these data through a back-end control platform (not shown). The data of each probe 526 must be recorded, so that it can be determined where the top plate 42 of the raised access floor 40 is uneven.

In one embodiment, the sensors 524 and their corresponding probes 526 are provided in an array, such that the probes 526 may be provided in an array in a specific manner, which may be provided in rows, columns, or other specified orders. In a further embodiment, five sensors 524 and corresponding probes 526 are provided on each side. The five probes are provided on each side. Three rows are provided within the probes on the four sides. Six probes 526 are provided in the first row and the third row respectively. The six probes 526 are provided in two rows. Five probes 526 are provided in the second row. For example, these probes 526 are used to detect data from different positions of the top plate 42 of the raised access floor 40, and the planarity deviation of the top plate 42 of the entire raised access floor 40 is calculated. The worst data obtained at a certain position can be used as the planarity of this top plate 42. The data must be within the standard value to be qualified. For example, the error of the standard value is plus or minus two tenths of mm. If it exceeds plus or minus two tenths of mm, it is considered unqualified.

These four panel zero point positioning blocks 528 are respectively provided at the four corners of the detection surface S2 of the sensor fixing plate 522. For the convenience of explanation, the panel zero point positioning blocks 528 at different positions are illustrated with the first panel zero point positioning block SP1, the second panel zero point positioning block SP2, the third panel zero point positioning block SP3, and the fourth panel zero point positioning block SP4. The first plate surface zero point positioning block SP1, the second plate surface zero point positioning block SP2, the third plate surface zero point positioning block SP3, and the fourth board surface zero point positioning block SP4 are positioned at the four corners of these probes 526, so that the size range formed by the first plate surface zero point positioning block SP1, the second plate surface zero point positioning block SP2, the third plate surface zero point positioning block SP3, the fourth board surface zero point positioning block SP4, and these probes 526 can cover the top plate 42 of the raised access floor 40 as shown in FIG. 2.

In addition, the detection surface S2 of the sensor fixing plate 522 may be further provided with four fixing portions B1. The four fixing portions B1 are, for example, perforations of locking elements, which may connect the connecting posts 5132 shown in FIG. 1 or FIG. 3 together.

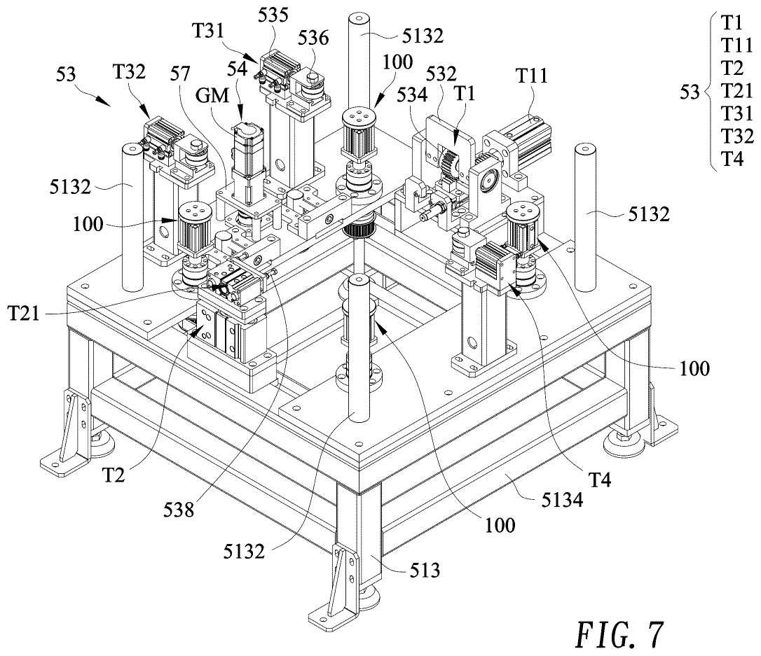

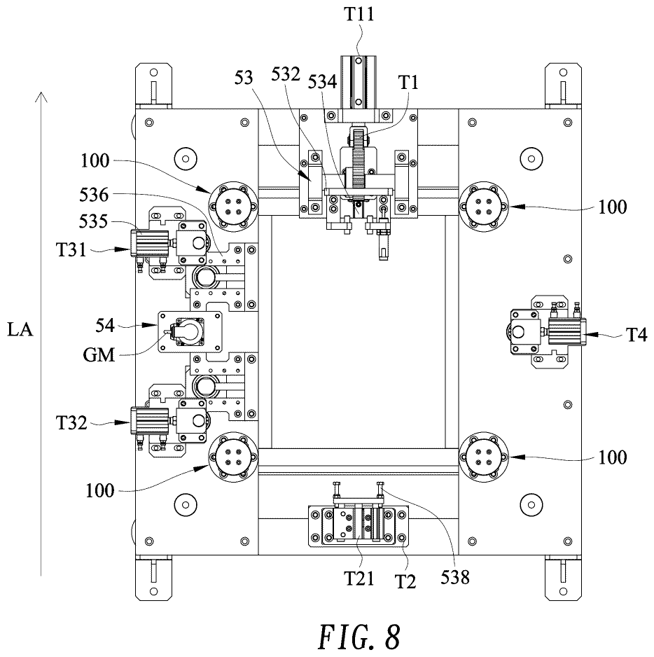

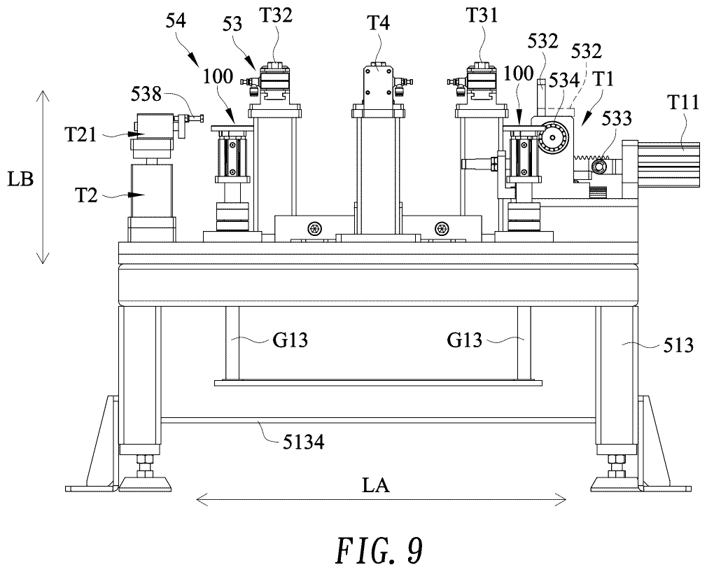

FIG. 7 is a three-dimensional schematic diagram of a positioning device and a elevating device for A raised access floor according to the present disclosure. FIG. 8 is a schematic top view of the positioning device and the elevating device of the raised access floor according to the present disclosure. FIG. 9 is a side view of a positioning device and a elevating device for A raised access floor according to the present disclosure. Please refer to FIGS. 2, 3, 7 to 9. The conveying device 51 is used to convey the raised access floor 40 to the measuring station LA2 along the conveying direction LA, and the positioning device 53 is used to position the side panels 44 of the raised access floor 40, so that the position of the top plate 42 can be positioned on the measuring device 52, so that the position of the top plate 42 can correspond to the position of the detection surface S2 of the sensor fixing plate 522.

The positioning device 53 disclosed in the present invention is positioned at the measuring station LA2, and the positioning device 53 includes a first positioning element T1, a second positioning element T2, a third positioning element T31, a fourth positioning element T32, a fifth positioning element T4, a first pushing cylinder T11, and a second pushing cylinder T21, wherein the first positioning element T1, the first pushing cylinder T11, the second positioning element T2, and the second pushing cylinder T21 are provided along the conveying direction LA, the first pushing cylinder T11 is connected to the first positioning element T1, and the second pushing cylinder T21 is connected to the second positioning element T2. At least one positioning element is set on both sides of the conveying direction LA. Taking FIG. 3 as an example, two positioning elements, the third positioning element T31 and the fourth positioning element T32, are set on the left side of the conveying direction LA, and one positioning element, the fifth positioning element T4, is set on the right side of the conveying direction LA. It has the function of a pushing cylinder, which can push the raised access floor 40 toward the third positioning element T31 and the fourth positioning element T32 for positioning.

The first positioning element T1, the second positioning element T2, the first pushing cylinder T11, and the second pushing cylinder T21 are all positioned between the two chain assemblies 5144 in the conveying structure 514, the third positioning element T31 and the fourth positioning element T32 are positioned on one side of the two chain assemblies 5144 in the conveying structure 514, and the fifth positioning element T4 is positioned on the other side of the two chain assemblies 5144 in the conveying structure 514, that is, the third positioning element T31, the fourth positioning element T32 and the fifth positioning element T4 are positioned on the opposite sides of the first positioning element T1 and the second positioning element T2.

Along the conveying direction LA, the second positioning element T2 and the second pushing cylinder T21 connected to it are adjacent to the waiting station LA1, and the first positioning element T1 and the first pushing cylinder T11 connected to it are adjacent to the output station LA3. That is to say, when the elevated floor 40 is transmitted to the measuring station LA2 by the chain assembly 5144, the elevated floor 40 will first be transmitted via the second positioning element T2 and the second pushing cylinder T21 connected to it, and then the first positioning element T1 and the first pushing cylinder T11 connected to it. In the process of transmitting the elevated floor 40 from the second positioning element T2 to the first positioning element T1, the third positioning element T31, the fourth positioning element T32 and the fifth positioning element T4 are respectively positioned on both sides of the elevated floor 40, and the upper side of the top plate 42 of the elevated floor 40 is the measuring device 52.

Please refer to FIGS. 3, 7 and 9. The setting heights of the third positioning element T31, the fourth positioning element T32 and the fifth positioning element T4 are higher than the setting height of the chain assembly 5144, so that when the conveyed object (such as the elevated floor 40 in FIG. 2) passes through, the third positioning element T31, the fourth positioning element T32 and the fifth positioning element T4 on both sides of the chain assembly 5144 can be positioned on the left and right sides of the conveyed object (such as the elevated floor 40 in FIG. 2).

The setting height positions of the first pushing cylinder T11 and the second positioning element T2 are not higher than the setting height positions of the chain assembly 5144, so that the bottom side of the conveyed object (such as the elevated floor 40 in FIG. 2) will not hit the first pushing cylinder T11 and the second positioning element T2 when passing through. However, the first positioning element T1 is driven by the first pushing cylinder T11 and the second pushing cylinder T21 is driven by the second positioning element T2, so that the first positioning element T1 and the second positioning element T2 can protrude from the setting height positions of the chain assembly 5144, so that the first positioning element T1 and the second pushing cylinder T21 can be positioned at the front and rear sides of the conveyed object (such as the elevated floor 40 in FIG. 2) to position the elevated floor 40, and the first positioning element T1 and the second pushing cylinder T21 can not protrude from the setting height position of the chain assembly 5144, so that the conveyed object (such as the elevated floor 40 in FIG. 2) can pass through the measuring station LA2.

Specifically, the first positioning element T1 includes a positioning plate 532, a rack 533, and a gear 534. As shown in the FIG. 9, one end of the rack 533 is connected to the first pushing cylinder T11, the other end of the rack 533 is connected to the gear 534, and the gear 534 is connected to the positioning plate 532, thereby forming a structure. The first pushing cylinder T11 pushes the rack 533 so that the rack 533 drives the gear 534 to rotate the positioning plate 532 at the positioning position or retracted position shown in the FIG. 9 (such as the positioning plate 532 indicated by the dotted line in the FIG. 9). The positioning plate 532 at the positioning position shown in the FIG. 3 is higher than the arrangement of the chain assembly 5144 The height position is used to contact one of the conveyed objects (such as the elevated floor 40 in FIG. 3 to block the elevated floor 40 from moving forward for positioning; on the contrary, if it is the positioning plate 532 represented by the dotted line in FIG. 9, the positioning height of the positioning plate 532 represented by the dotted line in the ninth Fig. is not higher than the positioning height position of the chain assembly 5144.

As shown in FIG. 3, the setting position of the second pushing cylinder T21 is not higher than the setting height position of the chain assembly 5144. In one embodiment, as shown in FIG. 9, by driving the second positioning element T2, the second pushing cylinder T21 can be moved up and down in a elevating direction LB, so that the second pushing cylinder T21 can be positioned outside the origin position shown in FIG. 3, and the second pushing cylinder T21 can also protrude from the setting position of the chain assembly 5144, so that the setting height of the second pushing cylinder T21 is higher than the setting height of the chain assembly 5144. In one embodiment, the second pushing cylinder T21 includes two contact members 538, which are used to contact the other side of the transported object (such as the elevated floor 40 in FIG. 2) for positioning purposes when the setting height of the second pushing cylinder T21 is higher than the setting height of the chain assembly 5144.

The third positioning element T31, the fourth positioning element T32 and the fifth positioning element T4 are positioned on both sides of the two chain assemblies 5144 in the conveying structure 514. Taking the third positioning element T31 as an example, the third positioning element T31 includes a pushing cylinder 535 and a circular roller 536, and the pushing cylinder 535 is connected to the circular roller 536. The structural form of the fourth positioning element T32 and the fifth positioning element T4 is the same as the third positioning element T31, and also includes a pushing cylinder 535 and a circular roller 536. In this structural setting, the pushing cylinder 535 pushes the circular roller 536 so that the circular roller 536 can move in the direction of the chain assembly 5144. The circular roller 536 is used to contact the left and right sides of the conveyed object (such as the elevated floor 40 in FIG. 2) for positioning purposes.

In addition, as shown in FIG. 1, in addition to being provided at the measuring station LA2, in one embodiment, a positioning element 56 is provided at the output station LA3 for positioning the transported object (such as the elevated floor 40 in FIG. 2) when it is removed. The structure of the positioning element 56 may be the same as the structure of the aforementioned third positioning element T31.

Please refer to FIG. 3 and FIG. 7 to FIG. 9 again. The elevating device 54 of the elevated floor disclosed in the present invention is positioned at the measuring station LA2 and is used to lift the elevated floor 40 shown in FIG. 2. The elevating device 54 of the elevated floor includes four elevating mechanisms 100 and a driving motor GM. The elevating mechanisms 100 are used to carry and lift the back side 46 of the elevated floor 40 as shown in FIG. 2, wherein the loading seat 57 is arranged above the supporting frame 513, and the driving motor GM is fixed on the loading seat 57. The driving motor GM is used to drive the four elevating mechanisms 100 to move synchronously along the elevating direction LB to move the elevated floor 40 as shown in FIG. 2 along the elevating direction LB to move the elevated floor 40 away from the chain assembly 5144 shown in FIG. 1 and close to the measuring device 52. Since the four elevating mechanisms 100 are supported at four corners of the elevated floor 40 respectively, they can be elevated and lowered smoothly. In other embodiments, the four elevating mechanisms 100 may each have a driving mechanism that sets torque to achieve the purpose of synchronously elevating the four elevating mechanisms 100 to a predetermined position at the same time.

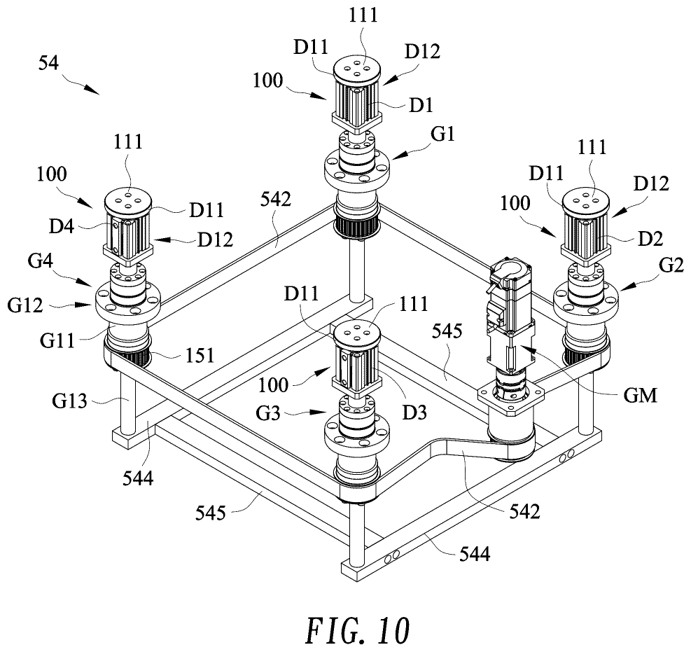

FIG. 10 is a perspective schematic diagram of an embodiment of a elevating device for an elevated floor according to the present disclosure. Please refer to FIG. 10. The elevating device 54 of the elevated floor disclosed in the present invention includes four elevating mechanisms 100, a driving motor GM, a belt 542, and two first supporting plates 544 and two second supporting plates 545. The two ends of the two first supporting plates 544 are respectively connected to two second supporting plates 545. The two first supporting plates 544 and the two second supporting plates 545 are connected to constitute a square frame, and the four screw rods G13 synchronously perform ascending and descending linear motions, so that the screw rods G13 in the four elevating mechanisms 100 can synchronously drive the contact blocks D12 of the elevating device 54 of the elevated floor to synchronously contact the four corners of the elevated floor. The positions of these four elevating mechanisms 100 can correspond to the positions of the first plate surface zero point positioning block SP1, the second plate surface zero point positioning block SP2, the third plate surface zero point positioning block SP3, and the fourth board surface zero point positioning block SP4 in the measuring device 52 as shown in FIG. 5. These four elevating mechanisms 100 will synchronously move the elevated floor 40 along the elevating direction LB and contact the first plate surface zero point positioning block SP1, the second plate surface zero point positioning block SP2, the third plate surface zero point positioning block SP3, and the fourth board surface zero point positioning block SP4.

The driving motor GM is positioned between two of the elevating mechanisms 100. The belt 542 is wound around the transmission wheels 151 of the four elevating mechanisms 100 and the driving motor GM to constitute a synchronous driving mechanism. The contact blocks D12 of the four elevating mechanisms 100 correspond to the position of the first plate surface zero point positioning block SP1, the position of the second plate surface zero point positioning block SP2, the position of the third plate surface zero point positioning block SP3, and the position of the fourth plate surface zero point positioning block SP4 in the measuring device 52 as shown in FIG. 5.

In this way, the driving motor GM can drive the belt 542 to rotate, and the belt 542 can drive the transmission wheels 151 of the four elevating mechanisms 100, so that the contact blocks D12 of the four elevating mechanisms 100 can perform elevating actions. Since the four elevating mechanisms 100 are driven by the same driving source (driving motor GM) and transmission structure (belt 542), the elevating action is performed synchronously, so that the contact block D12 can be elevated or lowered to a predetermined position, thus avoiding the occurrence of position difference in the elevating action of the four elevating mechanisms 100.

In one embodiment, the elevating mechanism 100 may include two independent elevating modes, namely a fast elevating module G1, G2, G3, G4 and a slow elevating module D1, D2, D3, D4. In addition to the aforementioned synchronous execution of the elevating actions of the four elevating mechanisms 100, the heights of the four elevating mechanisms 100 can be synchronously and quickly increased by the fast elevating modules G1, G2, G3, G4. In addition, the aforementioned fast elevating modules G1, G2, G3, G4 can be supplemented by the slow elevating modules D1, D2, D3, D4 to strengthen the fit to the four corners of the elevated floor 40.

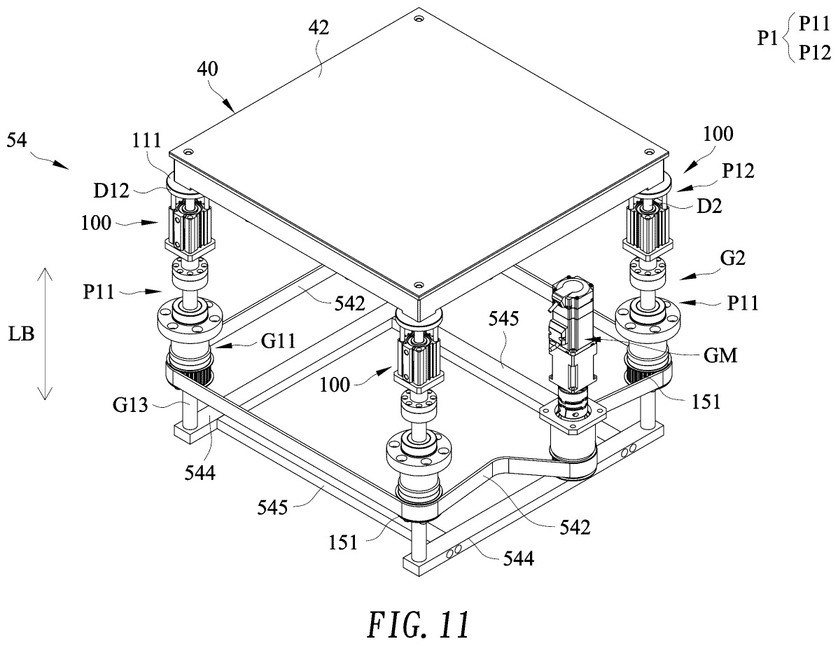

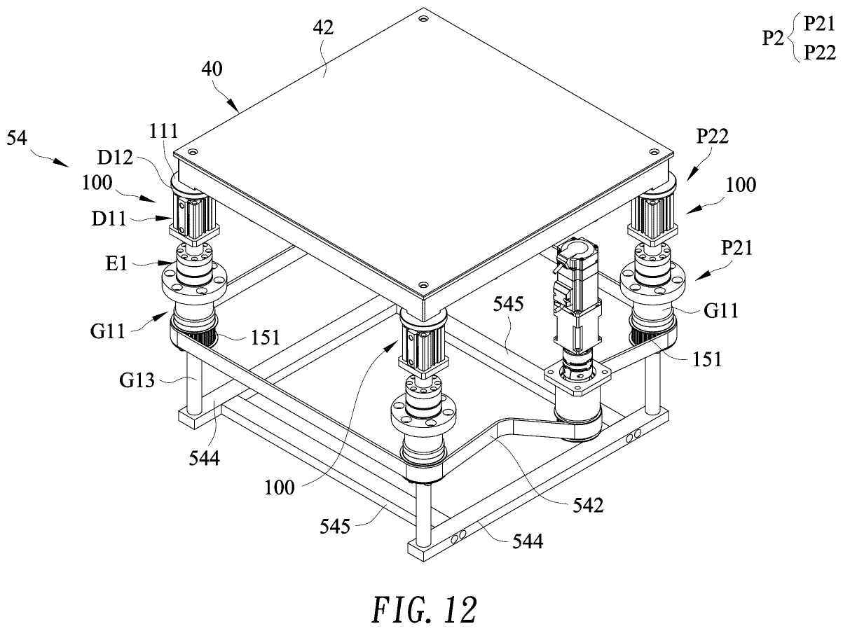

FIG. 11 is a schematic diagram of an embodiment of the elevating device of the elevated floor disclosed in the present invention in the elevating position, which illustrates an example of the elevating device 54 of the elevated floor in the elevating position P1 to raise the height position of the elevated floor 40. The elevating position P1 includes the elevating position P11 of the fast elevating modules G1, G2, G3, G4 and the elevating position P12 of the slow elevating modules D1, D2, D3, D4. FIG. 12 is a schematic diagram of an embodiment of the elevated floor elevating device disclosed herein at the origin position, which illustrates the origin position P2 of the elevated floor 40 before being elevated by the elevated floor elevating device 54. The origin position P2 includes the origin position P21 of the fast elevating modules G1, G2, G3, and G4 and the origin position P22 of the slow elevating modules D1, D2, D3, and D4.

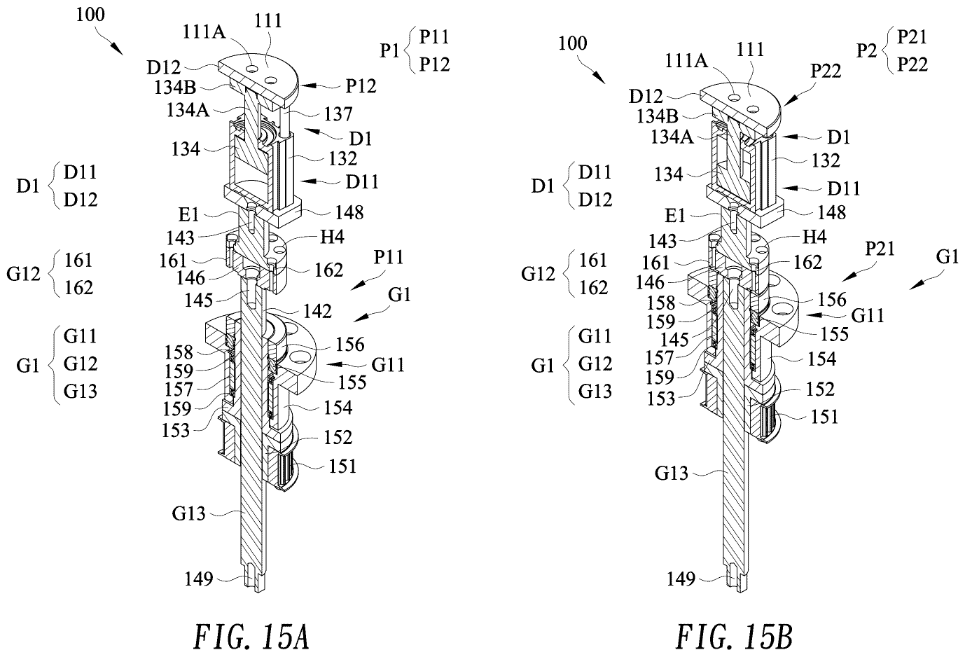

Referring to FIGS. 11 and 12. Each slow elevating module D1, D2, D3, D4 disclosed in the present invention is connected and arranged above the corresponding fast elevating modules G1, G2, G3, G4 of the elevating mechanism 100. The fast elevating module G1 includes a T-type nut connector G11, a connecting flange G12, and a screw G13. One end of the four screws G13 is respectively fixed to the two ends of the first supporting plate 544. In this way, the belt 542 drives the transmission wheel 151 to rotate, so as to synchronously drive the transmission wheel connecting piece 152 inside the transmission wheel 151 and the C-type nut 153 (as shown in FIG. 15A) connected thereto to rotate. At this time, since the first supporting plate 544 and the second supporting plate 545 at the bottom of the four screw rods G13 are fixed ends, the screw rods G13 cannot be rotated, and the transmission wheel 151 synchronously drives the transmission wheel connecting piece 152 and the T-type nut 153 connected thereto to rotate, and the T-type nut 153 can drive the screw rod G13 to perform vertical linear motion, such as the elevating position P11 shown in FIG. 11, so as to drive the slow elevating modules D1, D2, D3, D4 and the contact block D12 connected thereto to raise their height position, thereby raising the height position of the elevated floor 40. The transmission wheel 151 synchronously drives the transmission wheel connector 152 and the connected T-type nut 153 to rotate, and the T-type nut 153 drives the screw G13 to move up and down linearly, and quickly drives the screw G13 to rise linearly, that is, the rotational motion of the T-type nut 153 is converted into the linear motion of the screw G13, so as to quickly reach the purpose of rising position. In conjunction with the aforementioned method of simultaneously driving the four elevating mechanisms 100 through a single power source (driving motor GM), the elevated floor 40 is elevated synchronously and quickly to a predetermined height, and the position difference caused by the different rising positions of the four elevating mechanisms 100 can be avoided, thereby ensuring that the four corners of the elevated floor 40 can be smoothly elevated by the four elevating mechanisms 100, avoiding the height difference of the four corners of the elevated floor 40, and preventing the elevated floor 40 from slipping during the elevating process.

On the contrary, as shown in FIG. 12, the transmission wheel connector 152 and the T-type nut 153 connected thereto can be synchronously driven in the opposite direction in cooperation with the aforementioned transmission wheel 151, so that the protruding end 142 of the screw rod G13 and the pivotally connected connecting flange G12 thereof are reset to the origin position P21 as shown in FIG. 12, thereby driving the slow elevating modules D1, D2, D3, D4 and the contact block D12 connected thereto to be reset to their height positions.

In addition to the above-mentioned fast elevating modules G1, G2, G3, G4, please refer to FIGS. 11 and 12. The slow elevating modules D1, D2, D3, D4 disclosed in the present invention include a contact block D12 and a cylinder power source D11. The cylinder power source D11 is connected to the contact block D12, the gasket 111 is fixed on the contact block D12, and the other end of the cylinder power source D11 is connected to the fast elevating modules G1, G2, G3, and G4. The function of the slow elevating modules D1, D2, D3, and D4 disclosed herein is to complement the fast elevating modules G1, G2, G3, and G4. The four corner surfaces of the elevated floor 40 cannot be completely fitted to the position of the first plate surface zero point positioning block SP1, the second plate surface zero point positioning block SP2, the third plate surface zero point positioning block SP3, and the fourth plate surface zero point positioning block SP4 in the measuring device 52 due to the gaps between the components and the thickness tolerance of the four corners of the elevated floor 40 during processing, as well as the total error caused by various factors including but not limited to measuring tools. By utilizing the controllability of the air pressure of the cylinder power source D11, the cylinder power source D11 drives the contact block D12 to move so as to adjust the height position of the elevated floor 40.

Since the cylinder output can be adjusted according to the weight of the elevated floor 40 and by utilizing the air pressure regulation control and the limited unlimited position function of the cylinder, the elevated floor 40 can be elevated with the most appropriate force so that the four corner surfaces of the elevated floor 40 are completely fitted to the position of the first plate surface zero point positioning block SP1, the position of the second plate surface zero point positioning block SP2, the position of the third plate surface zero point positioning block SP3, and the position of the fourth plate surface zero point positioning block SP4 in the measuring device 52, thereby achieving the effectiveness and accuracy of the planarity measurement value.

In order to return the position of the probe 526 of the measuring device 52 to the origin, before measuring the planarity of the elevated floor, the probe 526 of the measuring device 52 is first zeroed and calibrated. The following example illustrates the zeroing and calibration of the automatic planarity measurement of the elevated floor disclosed in the present invention: First, a high-precision block gauge is selected, and its size is, for example, 600 mm×600 mm×60 mm. In one embodiment, the structure and size of the high-precision block gauge are the same as those of the elevated floor 40 shown in FIG. 2. The high-precision block gauge is placed in the waiting station LA1 as shown in FIG. 1, and the chain assembly 5144 in the conveying device 51 is used to move the high-precision block gauge to the measuring station LA2, so that the high-precision block gauge is positioned below the measuring device 52.

Next, when the front side of the high-precision block gauge hits the positioning plate 532 in the first positioning element T1 as shown in FIG. 3, the chain assembly 5144 stops conveying the high-precision block gauge. Next, the third positioning element T31, the fourth positioning element T32 and the fifth positioning element T4 positioned on both sides of the chain assembly 5144 begin to move, wherein the gears 536 of the third positioning element T31 and the fourth positioning element T32 can extend and move toward the direction of the high-precision block gauge to position the left side of the high-precision block gauge, and the gear 536 of the fifth positioning element T4 can extend and move toward the right side of the high-precision block gauge (i.e., toward the direction of the third positioning element T31 and the fourth positioning element T32) to push the high-precision block gauge toward the direction of the third positioning element T31 and the fourth positioning element T32, so that the high-precision block gauge can be close to the third positioning element T31 and the fourth positioning element T32, that is, the left and right sides of the high-precision block gauge are positioned by the third positioning element T31, the fourth positioning element T32 and the fifth positioning element T4. Finally, the second positioning element T2 drives the second pushing cylinder T21 to move, so that the second pushing cylinder T21 protrudes from the setting position of the chain assembly 5144, and allows the second pushing cylinder T21 to move toward the direction of the high-precision block gauge, that is, toward the direction of the first positioning element T1, and contacts the high-precision block gauge through the contact piece 538 of the second pushing cylinder T21, so that the high-precision block gauge can be pushed toward and close to the positioning plate 532 in the first positioning element T1. In this way, the four sides of the high-precision block gauge are positioned by the first positioning element T1, the second pushing cylinder T21, the third positioning element T31, the fourth positioning element T32 and the fifth positioning element T4 in the positioning device 53 to complete the position positioning of the high-precision block gauge.

Next, as shown in FIG. 9, the rack 533 is pushed by the first pushing cylinder T11, so that the rack 533 drives the gear 534 to rotate, so as to turn the positioning plate 532 from the positioning position shown in FIG. 9 to the retracted position (such as the positioning plate 532 represented by the dotted line in FIG. 9); on the other hand, the second pushing cylinder T21 is returned to the origin position by the second positioning element T2, that is, the setting height position of the second positioning element T2 is not higher than the setting height position of the chain assembly 5144; in addition, the third positioning element T31, the fourth positioning element T32 and the fifth positioning element T4 positioned on both sides of the chain assembly 5144 start to move and return to the origin position to move away from the high-precision block gauge to complete the reset action of the entire positioning device 53.

Next, as shown in FIG. 10, the drive motor GM is activated so that the drive motor GM can drive the belt 542 to rotate, and the belt 542 can drive the transmission wheel 151 of each elevating mechanism 100, so that the fast elevating modules G1, G2, G3, and G4 in each elevating mechanism 100 can synchronously and quickly raise the heights of the four elevating mechanisms 100, so that the high-precision block gauge can be elevated to a predetermined height by the four elevating mechanisms 100.

After the high-precision block gauge is elevated to a predetermined height by the fast elevating modules G1, G2, G3, and G4, the upper surface of the high-precision block gauge is then elevated by the slow elevating modules D1, D2, D3, and D4 to contact the position of the first plate surface zero point positioning block SP1, the position of the second plate surface zero point positioning block SP2, the position of the third plate surface zero point positioning block SP3, and the position of the fourth plate surface zero point positioning block SP4 in the measuring device 52. At this time, the first plate surface zero point positioning block SP1, the second plate surface zero point positioning block SP2, the third plate surface zero point positioning block SP3, and the fourth board surface zero point positioning block SP4 are positioned at the four corners of the probes 526. Therefore, when the upper surface of the high-precision block gauge contacts the first plate surface zero point positioning block SP1, the second plate surface zero point positioning block SP2, the third plate surface zero point positioning block SP3 and the fourth plate surface zero point positioning block SP4 in the measuring device 52, the probe 526 in the measuring device 52 will also touch the upper surface of the high-precision block gauge.

Finally, after confirming that all the probes 526 have touched the upper surface of the high-precision block gauge, the data obtained by these probes 526 are received by the corresponding sensors 524. These sensors 524 can receive these data and display these data through a back-end control platform (such as a BCS display), and all the data obtained by the probes 526 are reset to zero to complete the zero correction action of the automatic measurement of the planarity of the elevated floor.

Subsequently, the slow elevating modules D1, D2, D3, D4 and the fast elevating modules G1, G2, G3, G4 are reset so that the high-precision block gauge is again positioned on the two chain assemblies 5144 in the conveying structure 514. The high-precision block gauge is then transported from the measuring station LA2 to the output station LA3 through the chain assembly 5144, and then the rack 533 is pushed by the first pushing cylinder T11, so that the rack 533 drives the gear 534 to rotate, so as to rotate the positioning plate 532 from the retracted position shown in FIG. 9 back to the positioning position (such as the positioning plate 532 indicated by the solid line in FIG. 9) for receiving the next calibration work.

After the aforementioned zeroing calibration action of the automatic planarity measurement of the elevated floor, the position data of the probe 526 in the measuring device 52 is made zero, which serves as a reference for the subsequent planarity of the top plate of the elevated floor. The following example illustrates the automatic measurement action of the floor surface planarity of the elevated floor disclosed in the present invention: first, the elevated floor 40 shown in FIG. 2 is placed in the waiting station LA1 shown in FIG. 1, and the chain assembly 5144 in the conveying device 51 is used to move the elevated floor 40 to the measuring station LA2, so that the elevated floor 40 is positioned below the measuring device 52, and the top plate 42 faces the detection surface S2 of the measuring device 52, and these probes 526 face and are used to contact the top plate 42 of the elevated floor 40 shown in FIG. 2.

Next, when the front side of the elevated floor 40 hits the positioning plate 532 in the first positioning element T1 as shown in FIG. 3, the chain assembly 5144 stops conveying the elevated floor 40. Next, the third positioning element T31, the fourth positioning element T32 and the fifth positioning element T4 positioned on both sides of the chain assembly 5144 begin to move, wherein the circular rollers 536 of the third positioning element T31 and the fourth positioning element T32 can extend out and move toward both sides of the elevated floor 40 to position the left side of the elevated floor 40, and the circular roller 536 of the fifth positioning element T4 can extend out and move toward the right side of the elevated floor 40 (i.e., toward the direction of the third positioning element T31 and the fourth positioning element T32) to push the elevated floor 40 toward the direction of the third positioning element T31 and the fourth positioning element T32, so that the elevated floor 40 can be close to the third positioning element T31 and the fourth positioning element T32, that is, the left and right sides of the elevated floor 40 are positioned by the third positioning element T31, the fourth positioning element T32 and the fifth positioning element T4. Finally, the second positioning element T2 drives the second pushing cylinder T21 to move, so that the second pushing cylinder T21 protrudes from the setting position of the chain assembly 5144, and allows the second pushing cylinder T21 to move toward the elevated floor 40, that is, toward the direction of the first positioning element T1, and contacts the elevated floor 40 through the contact piece 538 of the second pushing cylinder T21, so that the elevated floor 40 can be pushed toward and close to the positioning plate 532 in the first positioning element T1. In this way, the four sides of the elevated floor 40 are positioned by the first positioning element T1, the second pushing cylinder T21, the third positioning element T31, the fourth positioning element T32 and the fifth positioning element T4 in the positioning device 53 to complete the position positioning of the elevated floor 40.

Next, as shown in FIG. 9, the rack 533 is pushed by the first pushing cylinder T11, so that the rack 533 drives the gear 534 to rotate, so as to turn the positioning plate 532 from the positioning position shown in FIG. 9 to the retracted position (such as the positioning plate 532 indicated by the dotted line in FIG. 9); on the other hand, the second pushing cylinder T21 is returned to the origin position by the second positioning element T2, that is, the setting height position of the second positioning element T2 is not higher than the setting height position of the chain assembly 5144; in addition, the third positioning element T31, the fourth positioning element T32 and the fifth positioning element T4 positioned on both sides of the chain assembly 5144 start to move and return to the origin position to move away from the elevated floor 40, so as to complete the reset action of all positioning devices 53.

Next, as shown in FIGS. 10 and 11, the drive motor GM is activated so that the drive motor GM can drive the belt 542 to rotate, and the belt 542 can drive the transmission wheel 151 of each elevating mechanism 100, so that the fast elevating modules G1, G2, G3, and G4 in each elevating mechanism 100 can synchronously and quickly raise the heights of the four elevating mechanisms 100, so that the elevated floor 40 can be elevated to a predetermined height by the four elevating mechanisms 100.

After the elevated floor 40 is elevated to a predetermined height by the fast elevating modules G1, G2, G3, and G4, the slow elevating modules D1, D2, D3, and D4 are then used to lift the top plate 42 of the elevated floor 40 to contact the position of the first plate surface zero point positioning block SP1, the position of the second plate surface zero point positioning block SP2, the position of the third plate surface zero point positioning block SP3, and the position of the fourth plate surface zero point positioning block SP4 in the measuring device 52. At this time, the first plate surface zero point positioning block SP1, the second plate surface zero point positioning block SP2, the third plate surface zero point positioning block SP3, and the fourth board surface zero point positioning block SP4 are positioned at the four corners of these probes 526. Therefore, when the top plate 42 of the elevated floor 40 contacts the first plate surface zero point positioning block SP1, the second plate surface zero point positioning block SP2, the third plate surface zero point positioning block SP3 and the fourth plate surface zero point positioning block SP4 in the measuring device 52, the probe 526 in the measuring device 52 will also touch the top plate 42 of the elevated floor 40.

Finally, the data obtained by these probes 526 are received by the corresponding sensors 524. These sensors 524 can receive these data and display them through a back-end control platform (such as a BCS display) to complete the automatic measurement of the planarity of the floor surface of the elevated floor, calculate the planarity deviation of the top plate 42 of the entire elevated floor 40, and the worst data obtained at a certain position can be used as the planarity of this top plate 42.

Subsequently, the slow elevating modules D1, D2, D3, D4 and the fast elevating modules G1, G2, G3, G4 are reset so that the elevated floor 40 is again positioned between the two chain assemblies 5144 in the conveying structure 514. The elevated floor 40 is then transported from the measuring station LA2 to the output station LA3 via the chain assembly 5144, and then the rack 533 is pushed via the first pushing cylinder T11, so that the rack 533 drives the gear 534 to rotate, so as to rotate the positioning plate 532 from the retracted position shown in FIG. 9 back to the positioning position (such as the positioning plate 532 indicated by the solid line in FIG. 9) for receiving the next measurement work.

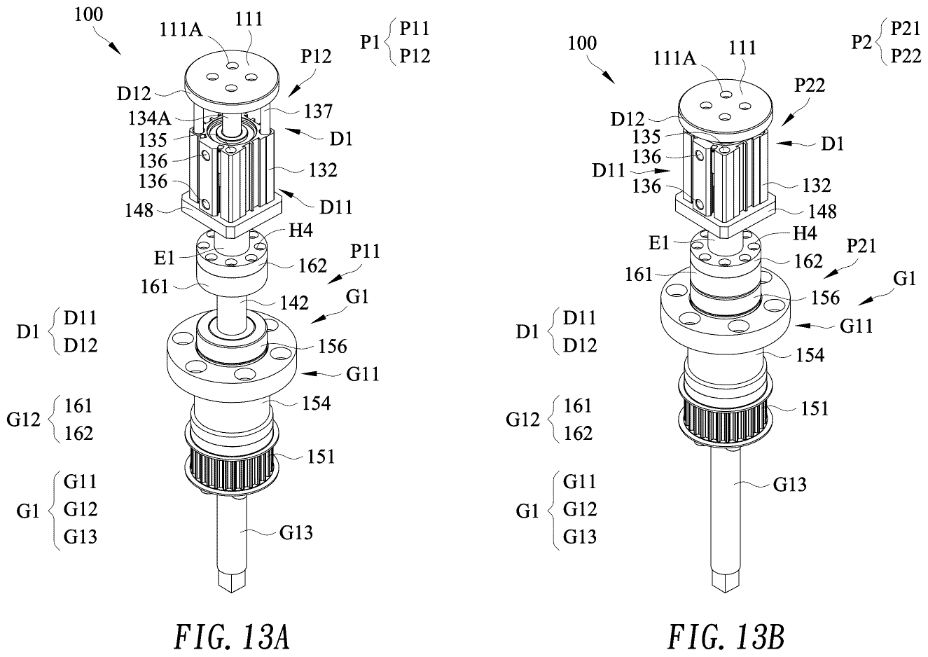

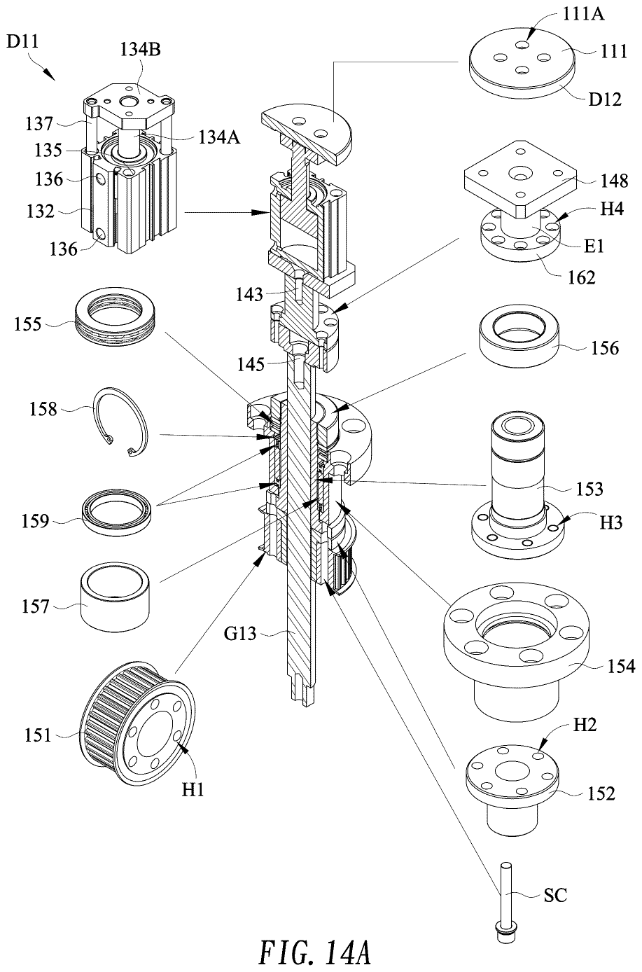

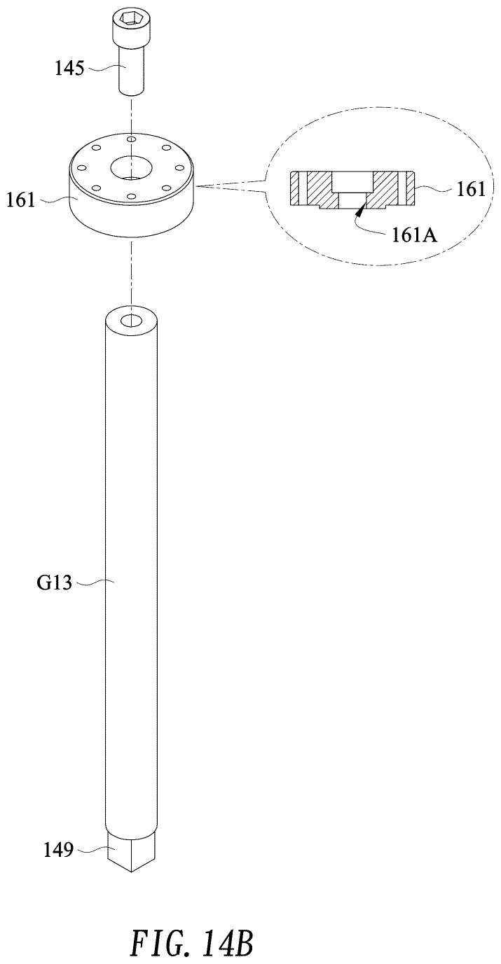

FIG. 13A is a schematic diagram of an embodiment of a elevating mechanism in a elevating position according to the present disclosure. FIG. 13B is a schematic diagram of an embodiment of a elevating mechanism at an origin position according to the present disclosure. FIG. 14A is an exploded view of the corresponding components in the cross-sectional diagram of the elevating mechanism according to the present disclosure. FIG. 14B is an exploded view of the lower connecting flange and the screw according to the present disclosure. FIG. 15A is a cross-sectional view of an embodiment of a elevating mechanism in a elevating position according to the present disclosure. FIG. 15B is a cross-sectional view of an embodiment of a elevating mechanism at an origin position according to the present disclosure. Please refer to FIGS. 13A to 15B, wherein the elevating position P1 of the elevating mechanism 100 in FIGS. 13A and 15A may correspond to the elevating mechanism 100 in FIG. 11, and the elevating position P1 includes the elevating position P11 of the fast elevating modules G1, G2, G3, and G4 and the elevating position P12 of the slow elevating modules D1, D2, D3, and D4; the origin position P2 in FIGS. 13B and 15B may correspond to the elevating mechanism 100 in FIG. 12, and the origin position P2 includes the origin position P21 of the fast elevating modules G1, G2, G3, and G4 and the origin position P22 of the slow elevating modules D1, D2, D3, and D4.

The elevating mechanism 100 includes a fast elevating module G1, a slow elevating module D1 and a T-type connector E1. The elevating mechanism 100 includes two independent elevating modes, namely a fast elevating module G1 and a slow elevating module D1, D2, D3, D4. The fast elevating modules G1, G2, G3, G4 can be quickly elevated to a predetermined height. The slow elevating modules D1, D2, D3, D4 are fixed above the fast elevating modules G1, G2, G3, G4. The slow elevating modules D1, D2, D3, D4 are elevated and lowered synchronously with the fast elevating modules G1, G2, G3, G4. The fast elevating module G1 includes a C-type nut connector G11, a connecting flange G12, and a screw G13, and the slow elevating module D1 includes a cylinder power source D11, a contact block D12, and a T-type connector E1.

The T-type nut connector G11 includes a transmission wheel 151, a transmission wheel connecting piece 152, a T-type nut 153, a bearing seat body 154, at least one bearing 155, a nut 156, a retaining frame 157, a C-type snap ring 158, and two deep groove bearings 159. The number of bearings 155 can be adjusted according to the structural configuration.

A transmission wheel connector 152 is disposed inside the transmission wheel 151, one side of a C-type nut 153 is connected to the transmission wheel connector 152. The C-type nut 153 can be fixed together with the transmission wheel 151 through the transmission wheel connector 152 and rotate synchronously.

In one embodiment, the bearing seat body 154 contains a T-type nut 153, which is a long through-screw hole, and the upper end of the T-type nut 153 has an external thread, and the lower end of the T-type nut 153 is connected and fixed to the transmission wheel 151 to rotate as a whole. For example, when assembling the T-type nut connector G11, the shaft of the transmission wheel connector 152 is first sleeved into the center hole of the transmission wheel 151, and the shaft of the T-type nut 153 is sleeved upward into the center hole of the bearing seat body 154, and then at least one fixing screw SC is sequentially penetrated through the perforation H1 of the transmission wheel 151, the perforation H2 of the transmission wheel connector 152, and the perforation H3 of the T-type nut 153, so as to lock and fix the transmission wheel 151, the transmission wheel connector 152 and the T-type nut 153 into one body, so that the transmission wheel 151 and the T-type nut 153 are connected and fixed into a body.

The bearing 155 is accommodated inside the bearing seat body 154. The bearing 155 is located between the C-type nut 153 and the bearing seat body 154. The nut 156 is locked on the outer thread of the upper end of the C-type nut 153 to fix the position of the bearing 155.

A C-type snap ring 158, two deep groove bearings 159, and a retaining frame 157 are inserted through the outer periphery of the C-type nut 153, and a deep groove bearing 159 is respectively arranged at the upper and lower ends of the retaining frame 157, and the positions of the two deep groove bearings 159 are fixed by the retaining frame 157. C-Ring Clip 158, also known as Circlip or Retaining Ring, is an elastic fastener used to fix parts or bearings in shafts or holes. It usually has a C-type or approximately circular structure with openings at both ends. After installation, the parts can be firmly fixed in a predetermined position through its elastic force. Taking this embodiment as an example, the C-type snap ring 158 is located between a deep groove bearing 159 and the bearing 155 to strengthen and fix the position of the bearing 155.

It should be noted that the deep groove ball bearing 159 is a rolling bearing characterized in that the raceways of its inner and outer rings have deep arC-type grooves and can withstand radial loads and certain axial loads.

The connecting flange G12 includes a lower connecting flange 161 and an upper connecting flange 162 connected to the lower connecting flange 161. The upper connecting flange 162 is arranged above the lower connecting flange 161. In one embodiment, bolts (not shown) are used to pass through the through holes H4 to lock and connect the upper connecting flange 162 and the lower connecting flange 161 into one body.

The upper end of the screw rod G13 is fixed to the lower connecting flange 161, and the lower end of the screw rod G13 is sequentially passed through the nut 156, the C-type nut 153, the bearing 155, the transmission wheel connecting member 152, and the transmission wheel 151. A first bolt 145 and a bolt head 146 are disposed above the T-nut connector G11. In one embodiment, the screw rod G13 includes an extended end 142, the upper end of the screw rod G13 is connected and fixed to a lower end of a first bolt 145, the upper end of the first bolt 145 is a bolt head 146, the first bolt 145 is passed through a countersink hole 161A of the lower connecting flange 161 and is locked in the screw hole at the upper end of the screw rod G13 to fix the screw rod G13 and the lower connecting flange 161 into one body, and the bolt head 146 is fixedly connected to the countersink hole 161A of the lower connecting flange 161. It can be seen that the bolt head 146 at the upper end of the first bolt 145 is used to fix the first bolt 145 to the lower connecting flange 161, and the protruding end 142 of the screw G13 is fixed to the lower connecting flange 161 by the first bolt 145. The first bolt 145 and its bolt head 146 are integrally formed as a bolt, and other fixing parts can also be used to replace the first bolt 145 and its bolt head 146. The present disclosure adopts a first bolt 145 for fixing.

In one embodiment, as shown in FIG. 14B, a countersunk hole 161A is provided in the lower connecting flange 161, and the first bolt 145 is passed through and located in the countersunk hole 161A. The countersunk hole 161A is a hole processed on the surface of the material, and is characterized in that there is a conical expansion hole at the hole mouth to accommodate the head of the countersunk screw (such as the first bolt 145), so that the head of the first bolt 145 can be flush with the surface of the lower connecting flange 161 or slightly lower than the surface. The countersunk hole 161A is designed mainly for aesthetics and functionality, for example, to prevent the head of the first bolt 145 from protruding and affecting the flatness or aesthetics of the lower connecting flange 161, so that the lower connecting flange 161 with a flat upper surface can be combined and fixed with the upper connecting flange 162.

The screw rod G13 is sequentially inserted through the nut 156, the C-type nut 153 and the transmission wheel connecting member 152 on the transmission wheel 151. The aforementioned T-nut connector G11, connecting flange G12 and screw G13 constitute a quick lifting module G1. The slow lifting module D1 includes a cylinder power source D11 and a contact block D12, and the contact block D12 is connected to the cylinder power source D11.

One end of the T-shaped connector E1 is connected to the upper connecting flange 162, and the other end of the T-shaped connector E1 is provided with a fixed base 148. The upper connecting flange 162 and the fixed base 148 at both ends of the T-shaped connector E1 are respectively connected to fix the fast lifting module G1 and the slow lifting module D1, that is, one end of the T-shaped connector E1 is connected and fixed to the fast lifting module G1 through the upper connecting flange 162, and the other end of the T-shaped connector E1 is connected and fixed to the slow lifting module D1 through the fixed base 148.

A fixed base 148 is provided at one end of the T-shaped connector E1, and a connecting flange 162 is connected to the other end of the T-shaped connector E1. The second bolt 143 is connected to a fixed base 148. The upper end of the T-shaped connector E1 is a fixed base 148. The lower end of the T-shaped connector E1 is an upper connecting flange 162. One upper end of the T-shaped connector E1 is connected and fixed to the bottom of the cylinder power source D11 through a second bolt 143 and a fixed base 148. The second bolt 143 is fixed in the same manner as the first bolt 145 mentioned above, that is, the fixed base 148 of the T-shaped connector E1 uses the second bolt 143 to pass through the bottom of the cylinder power source D11 and lock it in the screw hole of the fixed base 148 to connect and fix the cylinder power source D11 to the fixed base 148. It can be seen that the bottom of the cylinder power source D11 is connected and fixed to the fixed base 148 at the upper end of the T-shaped connector E1 by the second bolt 143, so that the connecting flange 162 and the fixed base 148 on both ends of the T-shaped connector E1 are respectively connected to fix the fast lifting module G1 and the slow lifting module D1. Other fixing members may be used to replace the second bolt 143. The present disclosure adopts the second bolt 143 for fixing.

When the driving wheel 151 rotates, the driving wheel connecting member 152 inside the driving wheel 151 and the T-nut 153 connected thereto are synchronously driven to rotate. The T-nut 153 is fixed inside the driving wheel 151. When the T-nut 153 rotates, the screw hole 149 at the bottom end of the screw rod G13 can be fixed to both ends of the supporting plate 544 using a screw (not shown) (as shown in FIGS. 10 to 12), so that the bottom end of the screw rod G13 serves as a fixed end, so that the screw rod G13 cannot be rotated. The T-nut 153 can drive the screw rod G13 to move up and down linearly. The up and down linear movement (or vertical movement) of the screw rod G13 refers to the movement of the screw rod G13 along a straight line in the vertical direction. The movement direction of the screw rod G13 is up and down, and the movement is performed along a straight line, such as the lifting position P11 shown in FIG. 13A or FIG. 15A, so as to drive the slow lifting module D1 and the contact block D12 connected thereto to raise its height position. The transmission wheel 151 drives the transmission wheel connector 152 and the C-type nut 153 connected thereto to rotate, so as to quickly drive the screw G13 to rise linearly, that is, to convert the rotational motion into linear motion, so as to quickly reach the purpose of the rising position.

On the contrary, as shown in FIG. 13B or FIG. 15B, the driving wheel 151 and the driving wheel connector 152 can be rotated in the opposite direction with the T-nut 153 connected thereto, so that the protruding end 142 of the screw rod G13 and the connecting flange G12 pivotally connected thereto are reset to the original position P21 shown in FIG. 13B or FIG. 15B, thereby driving the slow lifting module D1 and the contact block D12 connected thereto to be reset or lowered back to its height position.

The cylinder power source D11 includes a cylinder body 132, a piston 134, at least one perforation 135, at least one air inlet and outlet hole 136, and a plurality of fixing rods 137. The piston 134 can move within the cylinder body 132. The piston 134 includes a protruding end 134A and a top 134B. The protruding end 134A is connected to the top 134B. The top 134B is connected and fixed to the bottom of the contact block D12, so that the cylinder power source D11 slowly raises and lowers the corresponding contact block D12 to adjust the height of the contact block D12. One end of the fixing rod 137 is passed through the cylinder body 132, and the other end of the fixing rod 137 is connected to the top 134B, so that the piston 134 can evenly and balancedly lift the contact block D12 on the multiple fixing rods 137 to move up and down slowly, and the fixing rod 137 can be linked to the contact block D12.

In one embodiment, the cylinder body 132 is fixed to the bottom of the cylinder body 132 using a bolt (not shown) passing through the through hole 135. At least one air inlet and outlet hole 136 is provided on the cylinder body 132.

The aforementioned cylinder power source D11, contact block D12 and T-shaped connector E1 constitute a slow lifting module D1. By utilizing the controllability of the air pressure of the cylinder power source D11, the cylinder power source D11 drives the contact block D12 to move, and the piston 134 can move within the cylinder body 132, so that the protruding end 134A of the piston 134 and the top 134B connected thereto can drive the contact block D12 to slide on the fixed rod 137 to change its height position to rise to the lifting position P12 as shown in FIG. 13A or FIG. 15A, or the protruding end 134A of the piston 134 can drive the contact block D12 to change its height position to reset or move down to the origin position P22 as shown in FIG. 13B or FIG. 15B.

In one embodiment, the elevating mechanism 100 includes a gasket 111, and the gasket 111 is disposed on the contact block D12. The contact block D12 uses a bolt (not shown) to pass through a through hole 111A to fix the gasket 111 on the contact block D12.

It can be seen from this that the elevating mechanism 100 can include two independent lifting modes, namely a fast lifting module G1 and a slow lifting module D1. The function of the slow lifting module D1 disclosed in the present invention is to complement the fast lifting module G1. It can respond to the gaps between the components or the tolerances of the measuring tools. Since the cylinder output can be based on the weight of the object being lifted, and the air pressure regulation control and the limited and unlimited position function of the cylinder are utilized, the object being lifted can be lifted with the most appropriate force so that the object being lifted can be completely attached to the surface of another object.

In summary, the present invention measures the flatness of the elevated floor during the transmission process, thereby improving measurement accuracy, reducing errors or structural problems after assembly, and improving overall engineering efficiency.

Furthermore, the number of probes and sensors disclosed in the present invention can be adjusted according to the size or requirements of the ceiling of the elevated floor to be measured, so as to improve the accuracy of measuring flatness.

In addition, the present disclosure uses a zero point positioning block on the board surface to fix and confirm the position of the four corners of the measuring device and the top plate of the elevated floor to ensure the relative position of the probe and the top plate.

In addition, during the transmission process, the present disclosure uses a positioning device to position the four sides of the elevated floor to ensure the relative position of the elevated floor and the measuring device to ensure the accuracy of the subsequent measurement.

In addition, the present disclosure discloses a lifting device for an elevated floor, wherein the four elevating mechanisms are configured as a synchronous drive mechanism to synchronously perform the lifting action, so that the elevated floor can be lifted or lowered to a predetermined position, thereby avoiding the occurrence of position differences in the lifting action of the four elevating mechanisms.

Furthermore, the elevating mechanism disclosed in the present invention has two independent fast lifting modules and a slow lifting module. In addition to being able to quickly lift to a predetermined height through the fast lifting module, the air pressure of the slow lifting module can also be controlled to compensate for the fitting error.

Although the present disclosure has been disclosed as above by way of embodiments, it is not intended to limit the present disclosure. Anyone with ordinary knowledge in the technical field may make some changes and modifications without departing from the spirit and scope of the present disclosure. Therefore, the scope of protection of the present disclosure shall be based on the scope defined in the attached patent application.

What is claimed is:

1. A raised access floor planarity measurement device, suitable for transmitting and measuring the planarity of a top plate of A raised access floor, wherein a plurality of side plates of the raised access floor are respectively vertically connected to the four ides of the top plate, and the raised access floor planarity measurement device comprises:
A conveying device, further comprising a material waiting station, a measuring station, and an output station along a conveying direction, wherein the measuring station is positioned between the material waiting station and the output station, and the conveying device is used to convey the raised access floor along the conveying direction;
A measuring equipment, positioned at the measuring station, further comprising a sensor fixing plate, a plurality of sensors, a plurality of probes, and four plate surface zero point positioning blocks, wherein the sensor fixing plate further comprises a receiving portion and a detection surface, the sensors are respectively provided at different positions of the receiving portion, the positions of the probes correspond to the positions of the sensors, and the probes are connected to the corresponding sensors, one end of the probes protrudes from the detection surface of the sensor fixing plate, and the probes are provided in an array, and the four plate surface zero point positioning blocks are respectively provided at four corners of the detection surface of the sensor fixing plate;
A positioning device positioned at the measuring station, wherein when the conveying device is used to convey the raised access floor to the measuring station along the conveying direction, the top plate of the raised access floor is positioned below the sensor fixing plate, and the positioning device is used to position the side plates of the raised access floor so that the position of the top plate can correspond to the position of the detection surface of the sensor fixing plate; and
An elevating device for A raised access floor is positioned at the measuring station. The elevating device for the raised access floor includes four elevating mechanisms and at least one driving motor. The four elevating mechanisms are respectively used to support the four corners of the raised access floor, and the positions of the four elevating mechanisms correspond to the positions of the four zero-point positioning blocks of the board surface in the measuring equipment. The at least one driving motor drives the four elevating mechanisms to move synchronously along a elevating direction to move the raised access floor along the elevating direction and contact the four zero-point positioning blocks of the board surface.

2. The planarity measuring equipment for raised access floors as claimed in claim 1, wherein five of the probes are provided at four sides, and a first row, a second row and a third row of probes are provided within the probes positioned at the four sides, and six probes are provided in two rows in the first row and the third row respectively, and the six probes are provided in two rows, and the probes in the second row are provided with five probes, and those probes face the top plate.

3. The planarity measurement device of the raised access floor as claimed in claim 1, wherein the positioning device includes a first positioning element, a second positioning element, a third positioning element, a fourth positioning element, a fifth positioning element, a first pushing cylinder, and a second pushing cylinder, moreover, the first positioning element, the first pushing cylinder, the second positioning element, and in the conveying direction, is provided with the first positioning element, the first pushing cylinder, the second positioning element, and the second pushing cylinder, the first pushing cylinder is connected to the first positioning element, the second pushing cylinder is connected to the second positioning element, the third positioning element, the fourth positioning element, and the fifth positioning element are provided on both sides of the conveying direction, the first positioning element includes a positioning plate, a rack, and a gear, what is more, one end of the rack is connected to the first pushing cylinder, and the other end of the rack is connected to the gear while the gear is connected to the positioning plate, moreover, the conveying device comprises a conveying structure which has the conveying direction, the conveying structure is a chain transmission driving structure, what is more, the conveying structure comprises two chain assemblies, while the measuring equipment is provided on the two chain assemblies, what is more, the first positioning element, the second positioning element, the first pushing cylinder and the second pushing cylinder are respectively positioned between the two chain assemblies, what is more, by driving the second positioning element, the second pushing cylinder can be raised and lowered and moved in a elevating direction, so that the second pushing cylinder can protrude from the position of the two chain assemblies.

4. The planarity measurement device, for raised access floors as claimed in claim 3, wherein the conveying structure further includes a main body, a first gear assembly and a second gear assembly, and a driving motor, wherein the first gear assembly and the second gear assembly are respectively provided at two ends of the main body, and the chain assembly is respectively connected to the first gear assembly and the second gear assembly, and the driving motor is connected to the second gear assembly. When the driving motor drives the second gear assembly, the second gear assembly drives the chain assembly to rotate, and the chain assembly rotates to drive the first gear assembly to rotate, so that the first gear assembly and the second gear assembly can rotate synchronously, so that the chain assembly can move along the conveying direction.

5. A raised access floor planarity measurement device, as claimed in claim 4, wherein the conveying device comprises a first frame, a second frame, a supporting frame, and a conveying structure, the first frame and the second frame are respectively provided under the conveying structure, the supporting frame is positioned between the first frame and the second frame, while the first frame is positioned at the material waiting station in the conveying structure, the second frame is positioned at the output station in the conveying structure, the supporting frame is positioned at the measuring station in the conveying structure, the measuring equipment, the positioning device and the raised access floor elevating device are respectively provided between the first frame and the second frame, and the measuring equipment, the positioning device and the raised access floor elevating device are respectively provided above the supporting frame; wherein the raised access floor planarity measurement device further comprises two limiting devices, which are respectively provided on both sides of the conveying structure.

6. A raised access floor planarity measurement device as claimed in claim 1, wherein the raised access floor elevating device comprises a belt, and two first supporting plates and two second supporting plates wherein the two ends of the first supporting plates are respectively connected to the second supporting plates to constitute a square frame, moreover, the four elevating mechanisms comprise a fast elevating module and a slow elevating module, what is more, each of the fast elevating modules comprises a screw and a transmission wheel, while each of the slow elevating modules comprises a contact block, wherein the lower ends of the screws of the four elevating mechanisms are respectively fixed to the two ends of the first supporting plates, and the belt is wound around the corresponding transmission wheels and the drive motors of the four elevating mechanisms to constitute a synchronous drive mechanism, what is more, the four contact blocks respectively correspond to the positions of the four plate surface zero point positioning blocks.

7. The raised access floor planarity measurement device as claimed in claim 6, wherein each of the slow elevating modules is fixed above the corresponding fast elevating module, and each of the slow elevating modules rises and falls synchronously with the corresponding fast elevating module.

8. The planarity measuring equipment for raised access floors as claimed in claim 7, wherein each of the fast elevating modules comprises a T-type nut connector and a connecting flange, moreover, the T-type nut connector comprises a T-type nut, at least one bearing, a nut, a transmission wheel connecting piece, and the transmission wheel, what is more, the T-type nut can be fixed together with the transmission wheel and rotate synchronously through the transmission wheel connecting piece, whereas the connecting flange comprises an upper connecting flange and a lower connecting flange, the upper connecting flange is connected to the lower connecting flange, an upper end of the screw rod is fixed to the lower connecting flange, moreover, and the lower end of the screw rod is sequentially penetrated through the nut, the T-type nut, at least one bearing, the transmission wheel connecting piece and the transmission wheel.

9. The planarity measurement device for raised access floors as claimed in claim 8, wherein the four elevating mechanisms respectively include a T-type connector while each of the slow elevating modules respectively includes a cylinder power source, moreover, each of the cylinder power sources respectively includes a cylinder body and a piston, while each of the pistons can move within the corresponding cylinder body, what is more, each of the contact blocks is fixed to a top portion of the corresponding piston, so that the cylinder power source slowly elevates and lower the contact block to adjust the height of the contact block, furthermore, one end of each of the T-type connectors is connected to the upper connecting flange, while the other end of the T-type connector is provided a fixed base, what is more, the upper connecting flanges of both ends of each of the T-type connector and the fixed base are respectively connected and fixed to the fast elevating module and the slow elevating module.

10. The planarity measuring equipment for a raised access floor as claimed in claim 9, wherein the cylinder power source comprises at least one air inlet and outlet hole and a plurality of fixing rods, while at least one air inlet and outlet hole is also provided on the cylinder body, moreover, the piston comprises a protruding end which is again connected to the top portion, what is more, one end of the fixing rods is respectively passed through the cylinder body while the other end of the fixing rods is connected to the top portion so that the piston and the fixing rods can be linked to the contact block.

11. The planarity measurement device, for raised access floors as claimed in claim 8, wherein the T-type nut connector comprises a bearing seat body in which accommodates the bearing while the bearing is positioned between the T-type nut and the bearing seat body, moreover, the bearing which is positioned between the T-type nut and the bearing seat body, is accommodated inside the bearing seat body, moreover, the nut is locked and fixed to the upper end of the T-type nut so as to fix the position of the bearing, what is more, the transmission wheel connecting piece is fixed inside the transmission wheel, the transmission wheel drives the transmission wheel connecting piece and the T-type nut connected thereto to rotate making the T-type nut can drive the screw rod to move linearly up and down through rotation.

12. A planarity measuring equipment for a raised access floor as claimed in claim 11, wherein the T-type nut connector comprises a retaining frame, a C-type snap ring, and two deep groove bearings, wherein the C-type snap ring, the two deep groove bearings and the retaining frame are respectively passed through the outer periphery of the T-type nut, moreover, a deep groove bearing is respectively provided at both the upper and lower ends of the retaining frame, the position of the two deep groove bearings is fixed by the use of the retaining frame, what is more, the C-type snap ring is positioned between one of the deep groove bearings and the bearing to fix the position of the bearing.

13. A planarity measurement device for a raised access floor as claimed in claim 9, wherein the upper end of the screw rod is connected and fixed to a lower end of a first bolt, while the upper end of the first bolt is a bolt head, and the first bolt is penetrated into a countersunk hole of the lower connecting flange and locked in a screw hole at the upper end of the screw rod, so as to fix the screw rod and the lower connecting flange into one body, moreover, the bolt head is fixed and connected to the countersunk hole of the lower connecting flange, what is more, by the use of a second bolt to penetrate into the bottom of the cylinder power source and to be locked and fixed in a screw hole of the fixed base so as to connect and fix the cylinder power source to the fixed base.

14. The raised access floor planarity measuring equipment as claimed in claim 8, wherein the drive wheel and the T-type nut are fixed together by at least one fixing screw which is sequentially penetrated through a corresponding through-hole of the drive wheel, the drive wheel connector and the T-type nut so as to fix the transmission wheel and the T-type nut into a body.

15. A elevating mechanism, comprising:
A fast elevating module, capable of quickly raising to a predetermined height, further comprising:
a T-type nut connector, comprising a T-type nut, at least one bearing, a nut, a transmission wheel connector, and a transmission wheel, wherein the T-type nut can be fixed together with the transmission wheel and rotate synchronously through the transmission wheel connector;
a connecting flange, comprising an upper connecting flange and a lower connecting flange, the upper connecting flange being connected to the lower connecting flange; and
a screw rod, an upper end of which is fixed to the lower connecting flange, and a lower end of which is sequentially passed through the nut, the C-type nut, the at least one bearing, the transmission wheel connecting piece and the transmission wheel; and
A slow elevating module is fixed above the fast elevating module. The slow elevating module rises and falls synchronously with the fast elevating module. The slow elevating module further comprising:
a cylinder power source, comprising a cylinder body and a piston, the piston being movable within the cylinder body; and
a contact block is fixed to a top portion of the piston so that the cylinder power source slowly raises and lowers the contact block to adjust the height of the contact block; and
A T-type connector has one end connected to the upper connecting flange, and the other end of the T-type connector is provided with a fixed base. The upper connecting flanges and the fixed base at both ends of the T-type connector are respectively connected to fix the fast elevating module and the slow elevating module.
